(19) United States
(12) Patent Application Publication
(10) Pub. No.: US 2025/0217874 A1
(43) Pub. Date: Jul. 3, 2025

(54) SYSTEM AND METHOD FOR IMPROVED EXECUTION OF A MULTIPARTY TRANSACTION INVOLVING ELECTRONIC FUNDS DISBURSEMENT

(71) Applicant: RENT-A-CENTER WEST, INC., Plano, TX (US)

(72) Inventor: Jason Jude HOGG, St. Petersburg, FL (US)

(73) Assignee: RENT-A-CENTER WEST, INC., Plano, TX (US)

(21) Appl. No.: 19/081,893

(22) Filed: Mar. 17, 2025

Related U.S. Application Data
(63) Continuation of application No. 17/196,368, filed on Mar. 9, 2021, now abandoned.
(60) Provisional application No. 62/987,081, filed on Mar. 9, 2020.
(60) Provisional application No. 63/081,107, filed on Sep. 21, 2020.

(51) Int. Cl. G06Q 30/0601; G06Q 20/02; G06Q 20/12; G06Q 20/22; G06Q 20/34; G06Q 30/0645

(52) U.S. Cl. CPC G06Q 30/0641; G06Q 20/02; G06Q 20/12; G06Q 20/29; G06Q 20/351; G06Q 30/0635; G06Q 30/0645

(57) ABSTRACT

In an illustrative embodiment, systems and methods by which a computerized platform may interoperate with a web browser extension and a payment mechanism to permit an electronic multiparty funds disbursement transaction. The web browser extension may interoperate with a website visited by a user for the purpose of conducting a transaction, such as an online retail website. The web browser extension may introduce a mechanism for imposing certain constraints upon the transaction to ensure the integrity or security of the transaction. The web browser extension may interoperate with the aforementioned website so as to automatically conduct some or all of the steps associated with conducting a transaction thereon. In connection with such transactions, the systems and methods herein may use virtual payment card or other payment card that is devoted effectuating multiparty transactions of sorts contemplated herein.

### CROSS-REFERENCE TO RELATED APPLICATIONS

This application claims the benefit of U.S. patent application Ser. No. 17/196,368, filed on Mar. 9, 2021, claims the benefit of U.S. Provisional Patent Application Nos. 62/987,081 and 63/081,107, filed on Mar. 9, 2020, and Sep. 21, 2020, respectively, the contents of which are incorporated by reference.

### BACKGROUND

Herein is disclosed a system and method for improved execution of a funds disbursement scenario involving plural parties, and more particularly to a system and method for providing an efficient means of imposing certain constraints upon transactions involving plural parties and requiring efficient and secure funds disbursement in connection with such transactions.

While much attention has been given to leveraging technology to lend to small and medium sized businesses, little attention has been given to providing a scalable and compliant system, enabling merchants to extend a consumer financing solution based on proven credit criteria methodology. Retail sales in certain segments such as small and medium sized businesses may be inhibited by the lack of financing options. Consumers may be driven towards utilizing their unsecured revolving credit cards in order to make certain large purchases—resulting in higher costs and adversely impacting credit scores.

### SUMMARY

Against this background, the present subject matter was developed. According to some embodiments, a system for disbursement of funds associated with a multiparty transaction includes a computing device including a processing unit and a memory communicably connected with and readable by the processing unit. The memory unit contains instructions that, when executed by the processing unit, cause the processing unit to execute a web browser extension in response to a web browser executing on the processing unit having been navigated to a shopping cart page of a retail website. The extension includes instructions that, when executed, cause information from the shopping cart to be read by the extension. The extension imposes a constraint upon the multiparty transaction based upon the information. Finally, upon the extension determining satisfaction of the constraint, the extension initiates the disbursement of funds by injecting data into at least one field on a payment page native to the retail website.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion. In addition, the drawings are illustrative as examples of embodiments of the invention and are not intended to be limiting.

FIG. 1 depicts an embodiment of a system for multiparty disbursement of funds in connection with a multiparty transaction.

FIG. 2 depicts an embodiment of a method by which a multiparty transaction may be initiated.

FIG. 3 depicts an embodiment of a system for performing certain operations in connection with a multiparty transaction.

FIG. 4 depicts an embodiment of a user interface for performing certain operations in connection with a multiparty transaction.

FIG. 5 depicts an embodiment of a user interface for performing certain operations in connection with a multiparty transaction.

FIG. 6 depicts an embodiment of a user interface for performing certain operations in connection with a multiparty transaction.

FIG. 7 depicts an embodiment of a user interface for performing certain operations in connection with a multiparty transaction.

FIG. 8 depicts an embodiment of a system for performing certain operations in connection with a multiparty transaction.

FIG. 9 depicts an embodiment of a user interface for performing certain operations in connection with a multiparty transaction.

FIG. 10 depicts an embodiment of a method by which a multiparty transaction may be conducted.

FIG. 11 depicts an embodiment of a method by which a multiparty transaction may be conducted.

FIG. 12 depicts an embodiment of a user interface for performing certain operations in connection with a multiparty transaction.

FIG. 13 depicts an embodiment of a user interface for performing certain operations in connection with a multiparty transaction.

FIG. 14 depicts an embodiment of a user interface for performing certain operations in connection with a multiparty transaction.

FIG. 15 depicts an embodiment of a user interface for performing certain operations in connection with a multiparty transaction.

FIG. 16 depicts an embodiment of a method by which a multiparty transaction may be conducted.

FIG. 17 depicts an embodiment of a user interface for performing certain operations in connection with a multiparty transaction.

FIG. 18 depicts an embodiment of a user interface for performing certain operations in connection with a multiparty transaction.

FIG. 19 depicts an embodiment of a method for performing certain operations in connection with management of a consumer account in connection with a multiparty transaction involving a lease-to-own arrangement.

FIG. 20 depicts an embodiment of a method for performing certain operations in connection with management of a consumer account in connection with a multiparty transaction involving a lease-to-own arrangement.

FIG. 21 depicts an embodiment of a method for performing certain operations in connection with management of a consumer account in connection with a multiparty transaction involving a lease-to-own arrangement.

FIG. 22 depicts aspects of an embodiment of a system which may perform various methods described herein.

FIG. 23 depicts an embodiment of a computing device, such as a server, personal computer, smart phone, tablet, terminal, or portable smart device, which may perform the any of the computerized methods described herein.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Certain varieties of transactions involve funds disbursement scenarios involving plural parties and require that certain constraints be imposed upon some of the parties, either for the purpose of preserving the integrity of the transaction or for the purpose of security. For example, some purchase transactions may involve three parties: a retailer that offers goods for sale to the general public, a customer seeking to acquire goods from the retailer typically for household or personal use, and a financing company that, as a service to the retailer, offers a program to enable the customer to apply for financing at the retail location, select desired payment terms and checkout utilizing an existing card or mobile solution of their choice.

In accordance with some disclosed examples, such a transaction flow may start with a customer downloading and installing an app on a mobile device. The app may then be used to scan a bar code of an item they would like to purchase, and in response thereto the financing company executes a preapproval process for providing funds for purchasing the desired item. Various actions may be included in the preapproval process, such as entering or scanning identification of the customer (i.e. a driver's license), getting the customer's credit history information, etc. Financing information and terms are then presented on the customers device via the app. The customer may select and agree to such terms, and funds are provided to the customer. Funds may be provided by any of several methods. For instance, a direct settlement between the lender and retailer may be facilitated without the use of credit card networks by depositing the funds into a prepaid card account. The customer then uses this card at checkout to purchase the item.

Various options are available for providing financing. Some embodiments provide a hierarchical multi-lender origination platform that enables multiple lenders, and allows different categories of participants in the capital markets to evaluate the suitability of a proposed personal loan. In some implementations, the financing process may include a lease-to-own transaction. For instance, a lease-to-own company may offer a program to purchase goods from the retailer to provide them to consumers through a lease-to-own transaction as a service to the retailer. In such a scenario, where the customer is unable or unwilling to utilize cash or a consumer credit sale to acquire goods, the lease-to-own company will purchase, from the retailer, those goods identified by the customer and enter into a lease-to-own agreement with the customer for those goods.

To safeguard the integrity of the transaction, the lease-to-own company imposes certain constraints. The lease-to-own company will not enter into a lease-to-own arrangement in connection with a product that is consumable, disposable or otherwise not amenable to the potential of return by the customer to terminate the lease-to-own transaction. Thus, for example, flooring would not be the proper subject of a lease-to-own arrangement, because by its nature it is permanently installed and cannot be readily returned. A lease-to-own company may involve its personnel in the initiation of a lease-to-own arrangement to ensure that the leased product is of a proper nature. Alternatively, the lease-to-own company may establish a relationship with the retailer in advance of extending any such lease-to-own arrangements to ensure that the retailer will not offer its products to consumers on a lease-to-own basis, if they are not of a suitable variety.

To protect itself from the possibility of fraud, the lease-to-own company typically selects a funds disbursement mechanism in which the lease-to-own company remains in control of the initiation of the payment of the retailer. A lease-to-own company would not, for example, provide its customers with a payment tool (example: a payment card linked to an account titled in the name of the lease-to-own company) by which the consumer could initiate the payment, because such as choice would expose the company to fraud. Instead, the lease-to-own company may aggregate the sums owed to a given retailer in consideration of all of the transactions leased via its lease-to-own arrangements during a given month, and then initiate a lump-sum wire transaction to the retailer at the end of the month. This creates a difficulty on the part of the retailer related to reconciling the payment with the proper underlying sales transactions as recorded in the retailer's internal records.

The necessity of protecting the integrity of a lease-to-own transaction combined with the additional necessity of suppressing fraud in connection with its concomitant funds disbursement results in inefficiencies: relationships between the lease-to-own company and a retailer must be formed in advance, reconciliation of payments with underlying transactions is difficult and prone to error, and personal involvement of the personnel of the lease-to-own company may be required. These outcomes are inimical to the goal of efficient and proper functioning of a multiparty transaction involving funds disbursement.

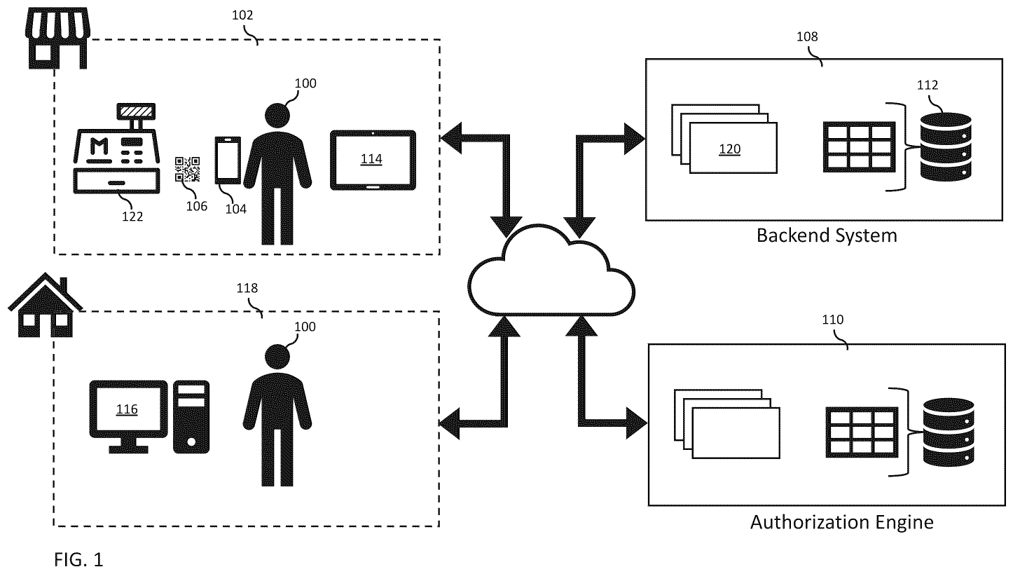

FIG. 1 depicts an embodiment of a system for multiparty disbursement of funds in connection with a multiparty transaction. Herein, various methods, apparatuses and systems are presented, and are discussed with reference to a lease-to-own company that offers lease-to-own arrangements to consumers. A lease-to-own arrangement is but one example of a multiparty transaction in which the methods, apparatuses and systems disclosed herein are useful, and the inventions disclosed herein are not limited to use solely in connection therewith. The methods, apparatuses and systems disclosed herein are useful in connection with lease-to-own arrangements and additionally with any form of financing arrangement, including but not limited to consumer financing arrangements, such as retail installment sales, revolving credit lines, open-ended accounts, and any form of secured or unsecured credit. Although reference is made herein to a lease-to-own company, such reference is made for the sake of illustration only. Moreover, although the particular transactional constraint referenced herein relates to suitability of a good for conveyance via a lease-to-own arrangement, the methods, apparatuses and systems disclosed herein are not so limited and may be adapted to apply to another such transactional constraint.

FIG. 1 depicts a consumer 100 located on the premises of a retailer 102. In the situation depicted by FIG. 1, the consumer 100 is desirous of acquiring a product offered for sale by the retailer 102 via a lease-to-own arrangement. According to some embodiments, the consumer 100 is in possession of a smart mobile device 104, such as a smart phone or tablet. The consumer 100 may use an app on his or her device 104 to access capabilities permitting the user to conduct some or all of the functions involved in creating a lease-to-own arrangement. For the sake of clarity, this app may be referred to herein as the “lease-to-own app” where confusion may arise as to which particular app is being referred to. Such an app may be published by a lease-to-own company offering lease-to-own arrangements to consumers. In some instances, the consumer 100 may not have the aforementioned app installed on his device 104. According to some embodiments, a barcode 106, such as a matrix barcode (example: a QR code) may be printed on an item or surface within the establishment 102, along with an instruction that informs the consumer 100 that scanning the barcode 106 with the camera integrated within the smart device 104 will result in a web browser installed on the device navigating to a site wherein the aforementioned app may be downloaded. According to this embodiment, the barcode 106 encodes a universal resource locator (URL) associated with a webpage wherein the user may initiate the process of downloading the aforementioned app. According to some embodiments, the particular app accessed by the consumer 100 to scan the barcode (example: a “camera app”) accesses capabilities exposed via the operating system of the device 104 to recognize and respond to the presence of a barcode in the visual data captured by the camera. The executable code providing these capabilities may be dynamically linked into the app's code space. The barcode 106 may also include information causing an app on the smart device (example: an “app store” app) to launch and open to a screen on which the aforementioned app is available for download. According to other embodiments, the retailer 102 may provide written or oral instructions directing the consumer 100 to download the app as a precondition to entry into a lease-to-own transaction.

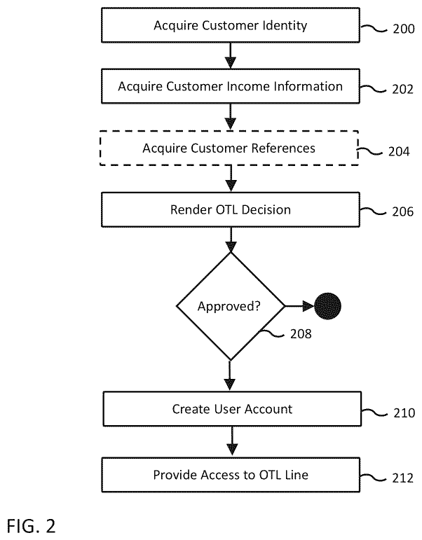

The lease-to-own app communicates and interoperates with a backend system 108 operated by or on behalf of a lease-to-own company extending lease-to-own arrangements. The backend system 108 may, according to some embodiments, communicate with a payment card transaction authorization platform 110 in order to provide the various functions involved in creating and managing a lease-to-own arrangement. In general, the lease-to-own app, backend system 108 and authorization platform 110 cooperate to performs the steps shown in FIG. 2. The operations of FIG. 2 are discussed in greater detail below, but are summarized here for the sake of simple introduction.

As can be seen from FIG. 2, the lease-to-own app and backend system 108 cooperate to acquire information concerning the identity of the consumer 100 (operation 200). During this operation, information such as the consumer's 100 name, address, date of birth, social security and telephone number may be acquired. The purposes of the information acquired in operation 200 include: (1) to provide certainty to the lease-to-own company with regard to the identity of the consumer 100 with whom it is dealing; (2) to provide sufficient identify information to the lease-to-own company so that it may construct a lease-to-own contract with the consumer 100; and (3) to provide information pertaining to the residence of the consumer 100, as that will be the likely location of any product leased by the company, should it come to pass that the product needs to be repossessed.

Thereafter, in operation 202 information pertaining to the consumer's 100 income is obtained. For example, during this operation, information such as the nature of the source of the consumer's 100 income (employment, social security, government aid, etc.) and the amount of income received by the consumer 100 on a periodic basis (such as weekly, biweekly, monthly, etc.). According to some embodiments, the lease-to-own app simply prompts the consumer 100 to manually enter such information. The purpose of the information collected in operation 202 includes providing the lease-to-own company with information about the stability and amount of the consumer's 100 income, so that it may formulate a decision about the aggregate cash price of all products it is willing to purchase from the retailer 102 and make available to the consumer 100 under active lease-to-own arrangements.

In operation 204, which may be an optional step, reference information is acquired. The reference information includes the names of one or more (example: three) individuals who know and have a relationship with the consumer 100, along with contact information of those individuals (example: telephone numbers or email addresses). The purpose of the information collected in operation 202 includes providing the lease-to-own company with information concerning individuals the lease-to-own company may contact, should it come to pass that the company loses contact with the consumer 100 during the term of a lease-to-own arrangement.

In operation 206, a decision concerning whether to extend a lease arrangement to the consumer is made by software executing on the backend computing platform 108 and communicated to the app 300. Additionally, a limit value is determined and communicated to the app 300, wherein the limit value represents the aggregate cash price of all products it is willing to purchase from the retailer 102 (or other retailers) and make available to the consumer 100 under active lease-to-own arrangements. This limit value may be referred to herein as the consumer's 100 open-to-lease approval balance. It is of note that the decision process of operation 206 is not an approval for a specific lease-to-own transaction. Instead, it is a communication of the amount the lease-to-own company is willing to spend with retailers to acquire as-yet unidentified goods.

If the consumer 100 is in fact approved for participation in a lease-to-own arrangement (operation 208), operational flow proceeds to operation 210, wherein a user account is created for the consumer 100. This process includes establishing login credentials for the consumer, by which the consumer 100 may access his account via the app 300 (and via other mechanisms as discussed below). The process also includes associating such credentials with internal records maintained in a datastore 112 in the backend computing platform 108, which present a transactional record reflecting account activity of the consumer 100. Such records may be referred to herein as the consumer's 100 account. For example, the consumer's 100 account reflects the consumer's 100 currently available open-to-lease approval balance, along with payment, fee and other transactional history for each of the consumer's 100 lease-to-own arrangements. These records may be organized on a product-by-product or contract-by-contract basis, and these records reflect amounts owed by the consumer (and scheduled renewal dates of such amounts owed), again on a product-by-product or contract-by-contract basis. According to some embodiments, the backend platform 108 manages the consumer's 100 account in such a way that a given consumer's 100 currently available open-to-lease approval balance is depleted as he or she leases products, but is restored as he or she makes payments, so that the open-to-lease approval balance is of the nature of a revolving account. This is discussed in more detail below. According to other embodiments, a consumer's 100 currently available open-to-lease approval balance may be adjusted on the basis of a review which may be conducted from time-to-time, such as on a periodic basis.

Finally, in operation 212, the consumer 100 is provided access to his or her account in order that he or she may use it to arrange for the acquisition of products from retailers (such as retailer 102) via lease-to-own transactions. Operation 200 may be conducted several ways, and is discussed in more detail below.

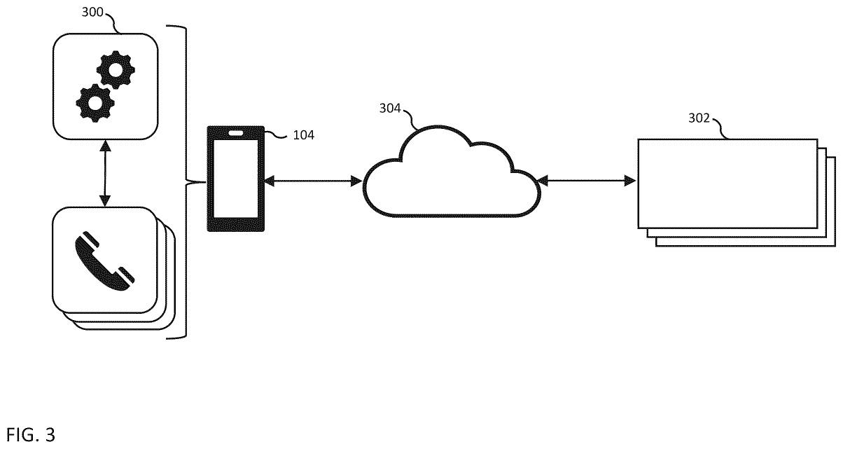

The discussion now returns to operation 200 of FIG. 2, for a more detailed discussion of this step. According to some embodiments, the app may prompt the consumer 100 to enter information identifying himself or herself via the device's 104 user interface, such as via a touchscreen keyboard or via voice-to-text capabilities, etc. Alternatively, the app may be designed to permit more convenient acquisition of such information. Turning momentarily to FIG. 3, therein is depicted the consumer's 100 mobile device 104 that has an embodiment of the lease-to-own app 300. The app uses the device's 104 networking capabilities (WiFi or data services typically provided by a cellular carrier) to communicate via a network 304, such as the Internet, with remote computing platforms 302. The remote computing platforms 302 include, for example, the aforementioned backend system 108 and other systems that may cooperate to aid in the performance of one or more of the operations of FIG. 2. For example, the remote computing platforms 302 may include an identification service 302, the services of which are consumed by the app 300. The identification service 302 may expose one or more application interfaces (API's) that the app 300 may interact with in order to obtain information identifying the consumer 100. For example, the identification service 302 may expose its API's as web services. The app 300 may send the consumer's telephone number and a portion of the consumer's 100 social security number (example: the final four digits of a social security number) to such web services, and the web services may respond by returning identifying information concerning the consumer 100, such as the consumer's 100 name, address, full social security number, and email address. According to some embodiments, the web services may also return information concerning the consumer's 100 income level, thereby either partially or entirely fulfilling the informational requirements of operation 202, and thereby potentially reducing or eliminating the need to prompt the consumer 100 for any such information pertaining to his or her income.

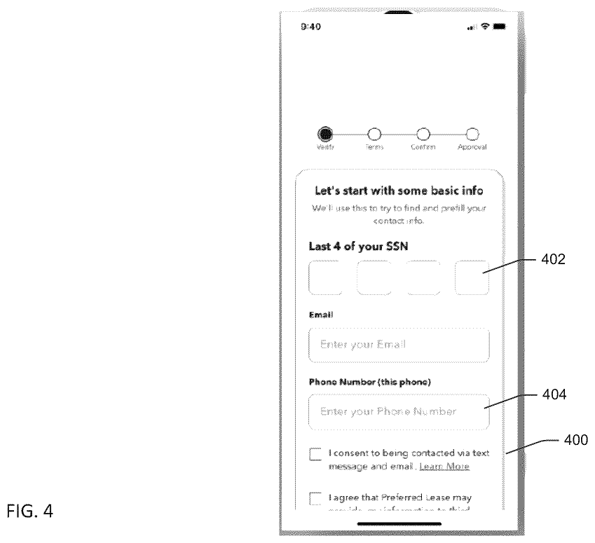

Continuing on with the preceding example, wherein the app 300 consumes web services exposed by an identification service 302, the app 300 may present a user interface screen 400 such as that depicted in FIG. 4. The screen 400 contains user input elements 402 by which the consumer 100 may enter the final four digits of his or her social security number. The screen 400 further contains a user input element 404 by which the consumer 100 may enter his telephone number. Other input elements may be provided. According to some embodiments, it is not required that the user manually enter his or her telephone number into the user input element 404. Instead, in the event that the device 104 is a smart phone 104, the app 300 may interact with another app 306 installed on the phone 104 (such as the “phone app” or a “contacts app”), and may acquire the telephone number via inter-process communication from another app 306 that has access to the telephone number assigned to the phone 104. Alternatively, the app 300 may access a capability made available by the phone's 104 operating system in order to acquire the phone number.

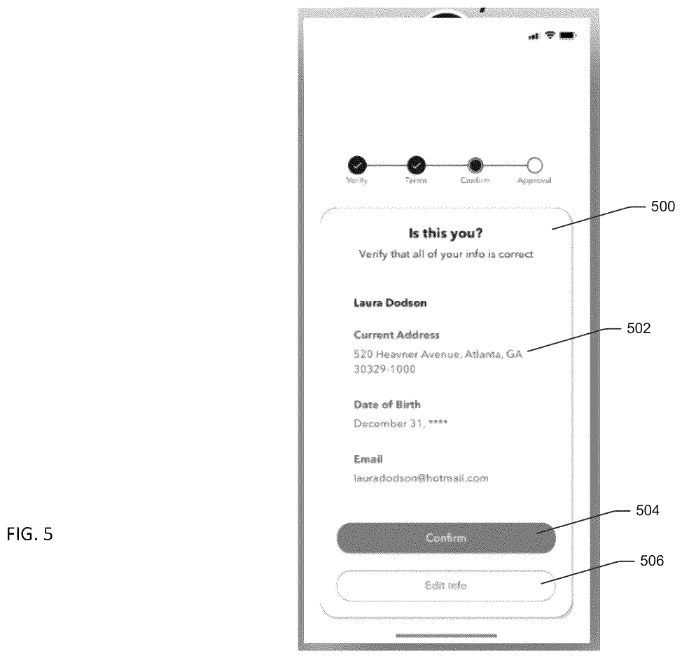

In the wake of having obtained the consumer's 100 identifying information via use of an identification service 302, the app 300 may present a user interface screen 500 such as the one depicted in FIG. 5. As can be seen therein, the screen 500 presents to the consumer 100 the identifying information 502 retrieved via the service 302 so that the consumer 100 may verify that the information is correct. The screen 500 contains a first button 504 by which the consumer may confirm the information, and a second button 506 by which the user can indicate that the information is incorrect and edit the information accordingly. According to some embodiments, the screen 500 may present only a portion of the identifying information 502 retrieved via the service 302 (example: last four digits of social security number, street number but no street name, and so on). Thus, the consumer 100 may review the portion that is presented via the screen 500 and confirm that such information 502 correctly corresponds to him or her, yet at the same time, should it be the case that the information 502 pertained to a different person, that other person's full address, social security number, and so on is not revealed.

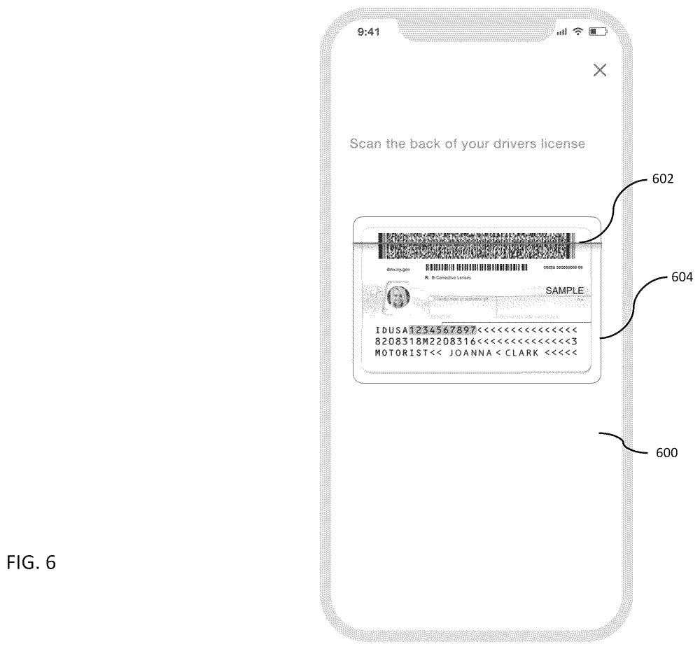

In the event that the user presses the second button 506 to indicate that the information was incorrect, the app 300 may present the consumer 100 with an alternative method by which his or her identification method may be conveniently obtained. For example, the app may present a user interface screen 600 such as the one shown in FIG. 6, while activating the camera onboard the consumer's 100 device 104. The screen 600 includes a camera view region 604 which depicts the image frame data being collected by the camera, and instructs the consumer 100 to scan the back of his or her driver's license with the camera. On the rear of the consumer's 100 driver's license is a matrix barcode 602, which, when presented in the field of view of the camera is recognized by the app 300. The app 300 may include capabilities to recognize the presence of the particular variety of matrix barcodes 602 on the rear of a driver's license, and to respond to such recognition by reading the data encoded thereon. The particular data set encoded on any given matrix barcode on a driver's license varies from state to state, but includes information sufficient to present a confirmatory screen, such as the screen 500 depicted in FIG. 5. In the event that other required identification information is not encoded on the matrix barcode 602, the app 300 may respond by prompting the consumer 100 to enter such information manually. Finally, in the event that identifying information cannot be obtained in a convenient manner either from an identification service 302 or from a matrix barcode 602 on a driver's license, the app 300 may simply prompt the user to enter the required information manually.

The discussion now returns to optional operation 204 of FIG. 2 (acquiring consumer 100 reference information), for a more detailed discussion of this step. According to some embodiments, the app 300 is configured to conduct inter-process communication with at least one other app installed on the device 104. In the event that the consumer's 100 device 104 is a smart phone, the app 300 may communicate with the native “phone app” in order to request that it return contact information stored therein. The app 300 receives the contact information from the app with which it conducted inter-process communication, and presents the information in a conveniently selectable format, so that the consumer 100 may provide reference information via the user interface of the app 300 without having to manually enter the information.

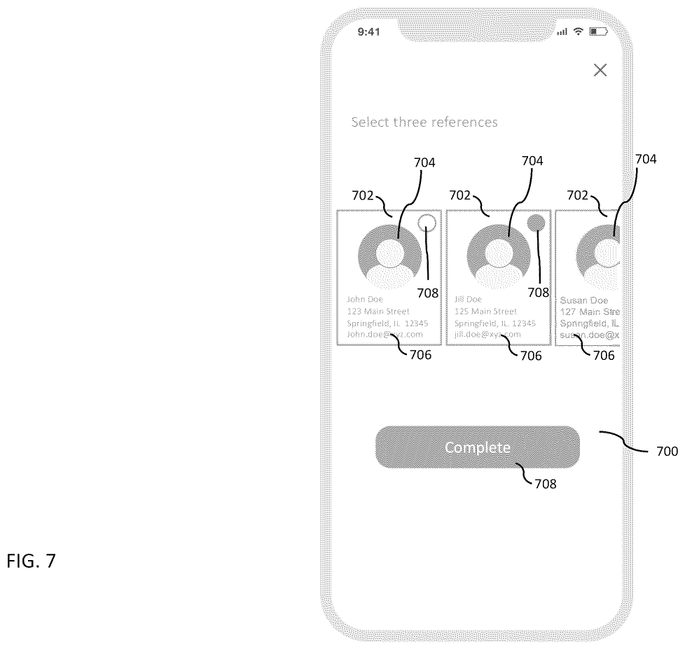

FIG. 7 depicts an embodiment of an exemplary user interface screen 700 for the selection of reference information in accordance with operation 204. As can be seen from FIG. 7, the screen 700 includes a series of tiles 702 arranged linearly. Each tile 702 contains information from an entry in the contacts list received from via inter-process communication. Thus, if the contacts list contained a quantity of n entries, there would be a quantity of n tiles 702 displayable via the screen 700. Each tile 702 contains a location to present an image 704 of the contact entry (if there is, in fact, an image associated with the entry within the contact information). Additionally, each tile 702 contains a location to present contact information 706, such as name, address, telephone number and email, for the entry corresponding to the tile 702. Finally, each tile 702 includes a selectable element 708. Selection of the element 708 indicates that the consumer 100 desires to use the contact presented in the tile 708 as a reference. The selectable element 708 may function as a toggle button, so that an initial tap of the element 708 indicates selection of the corresponding contact, while a subsequent tap of the element 708 cancels the selection. The linear array of tiles 702 may be scrollable, so that when swiped with a finger, the linear array 702 responds by re-indexing the particular tiles 702 actually visible within the field of view of the screen 700.

The consumer 100 uses the screen 700 of FIG. 7 by selecting the required number of contacts (via tap of the selectable elements 708), and then confirming the selection via tapping button 708 that is labeled “Complete.”

According to other embodiments, the app may be arranged to simply require the consumer 100 to manually enter the contact information of the individuals he or she intends to user as a reference.

The discussion now returns to operation 212 of FIG. 2 (providing the consumer 100 access to his or her open-to-lease approval balance), for an expanded introduction to this step. Providing the consumer 100 access to his or her open-to-lease approval balance may include permitting the consumer 100 to view his account information, including his currently available open-to-lease approval balance. It may also include permitting the consumer 100 to propose that a particular product from a particular retailer be leased via his or her lease-to-own line, and in the wake of a decision that such a product is the proper subject of a lease-to-own arrangement, enabling the execution an agreement establishing a lease-to-own arrangement between the lease-to-own company and the consumer 100. Finally, it may include permitting the consumer 100 to initiate a chain of events that results in payment being made to the retailer 102 for the product, and arranging for delivery of the product to the consumer 100, such as arranging for delivery of the product to the consumer's 100 residence or to another residence determined by the consumer 100. As is discussed below, the various embodiments teach systems and methods by which the consumer 100 may access his or her open-to-lease approval balance either without the establishment of a pre-existing relationship between the lease-to-own company and the retailer 102, or without requiring the involvement of personnel of the lease-to-own company.

The preceding discussion of FIGS. 1-7 has assumed that the consumer 100 was in possession of a portable device 104 such as a tablet or smart phone at the time he or she was at a retail location 102 and desiring to initiate a lease-to-own arrangement. This is not a requirement. According to some embodiments, the consumer 100 may access a website via a computing device 116 (example: smart phone, personal computer, tablet, etc.) while at a location that is physically remote from the retail location 102, such as the consumer's 100 home 118. The website is structured to cooperate with the backend system 108 to guide the consumer 100 through the operations of FIG. 2. Moreover, according to some embodiments, the retail location 102 is outfitted with a terminal 114, such as a computer or tablet. The terminal 114 may have software installed to cause it to cooperate with the backend system 108 and authorization engine 110 to perform the operations of FIG. 2, in a manner as described above with reference to execution on the consumer's 100 mobile device 104. According to some embodiments, the terminal 114 is unattended by personnel of the lease-to-own company and operated autonomously by the consumer 100 (as is the case when the consumer 100 launches the app 300 on his or her mobile device 104 and uses it). According to some embodiments, the terminal 114 is, in fact, attended by personnel of the lease-to-own company, and such personnel assist the consumer 100 in operation of the software installed thereon. Each of these scenarios are discussed in more detail below.

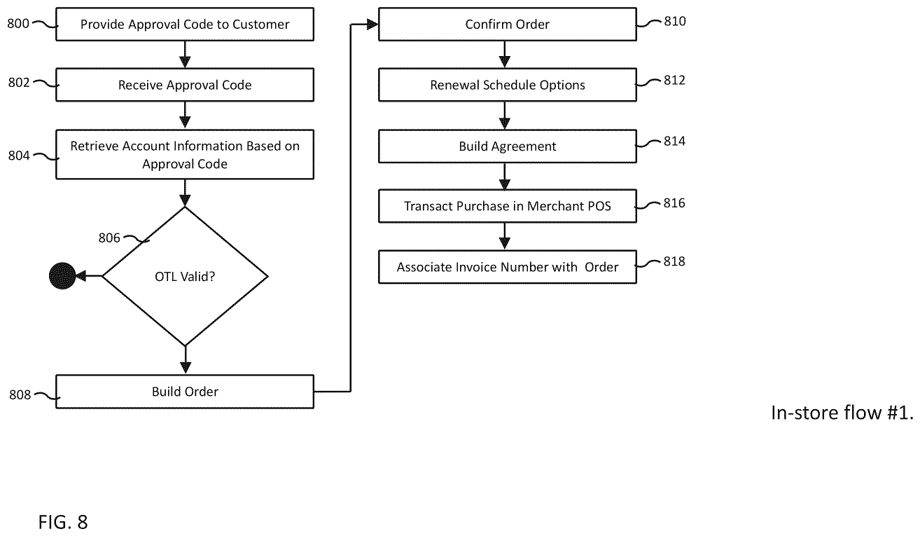

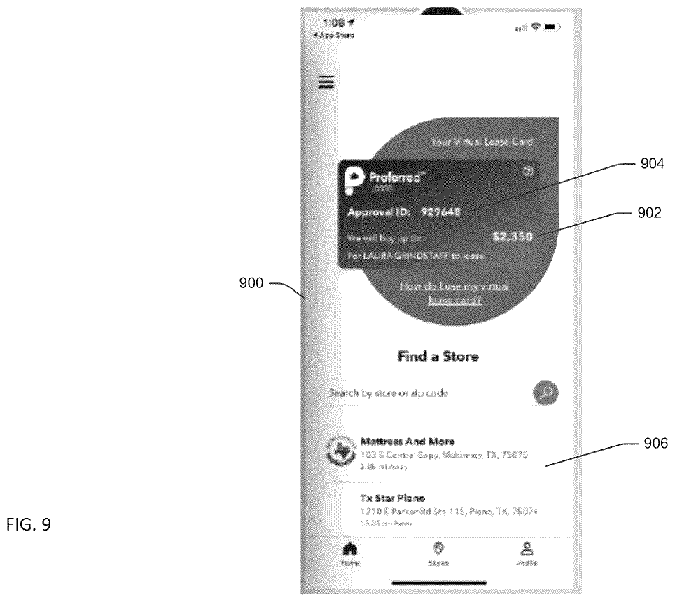

FIG. 8 depicts an embodiment of a method by which the consumer 100 may be provided access to his open-to-lease approval balance, as described with reference to operation 212 in FIG. 2. In the wake of the consumer 100 having received an approval for an open-to-lease approval balance (operation 208 of FIG. 2) and having created a user account (operation 210 of FIG. 2), an approval code may be provided to the user (operation 800). The approval code is uniquely associated with a given consumer's 100 open-to-lease approval balance and is generated in a pseudorandom manner, so that it cannot be anticipated. In the context wherein the operation 800 is performed by the app 300, the app may present a user interface screen 900 such as the one depicted in FIG. 9.

As can be seen from FIG. 9, the screen 900 includes an indication of the consumer's 100 currently available open-to-lease approval balance 902, and also presents an approval code 904 to the consumer 100. The screen 900 may also include an indication of retail locations 906 wherein the consumer 100 may lease products via a lease-to-own arrangement offered by the lease-to-own company. Thus, the consumer 100 is able to visit a retail location in person in order to continue the process of leasing a product via his or her lease-to-own line.

Once at a retail location 102, the consumer 100 either enters the approval code into the terminal 114 or communicates the code to personnel of the lease-to-own company who then enters the approval code into the terminal 114. The terminal 114 is executing software that can facilitate the construction of a lease-to-own arrangement between the lease-to-own company and the consumer 100, based on entry of an approval code. The software on the terminal 114 receives the approval code 904 (operation 802), and communicates the approval code to the backend system 108. According to some embodiments, the backend system 108 includes processes 120 that can interface with the datastore 112, and create, update, and delete records stored therein, including the various records constituting the consumer's 100 account information. These processes 120 may be extended as API's accessible as web services by the software running on the terminal 114. One or more of the processes 120 responds to invocation of its web service with the approval code 904 by the software on the terminal 114 by retrieving the consumer's 100 account information, including his or her currently available open-to-lease approval balance and returning it to the software on the terminal (operation 804).

It is possible that although the consumer 100 is in possession of an approval code 904, the consumer's 100 open-to-lease approval balance is no longer valid (i.e, the open-to-lease approval balance may have a value of $0.00). For example, in the intervening period between the point in time at which the approval code 904 was delivered to the customer 100 and the point in time at which the open-to-lease approval balance was retrieved via operation 804, the consumer 100 may have failed to make a payment on an existing lease-to-own obligation with the lease-to-own company. Thus, according to some embodiments, the consumer's 100 open-to-lease approval balance may be suspended during the period of his or her delinquency. (Account management is discussed in more detail below). Therefore, in operation 806 it is determined whether the consumer's 100 open-to-lease approval balance is still valid (i.e., whether it is greater than $0.00).

In the event that the open-to-lease approval balance is valid, control is passed to operation 808, wherein the consumer's 100 order is constructed. Construction of an order involves identifying the product or products that the consumer 100 intends to lease via a lease-to-own arrangement with the lease-to-own company. For example, the software on the terminal 114 may present a menu structure by which the operator of the software (either the consumer 100 or personnel of the lease-to-own company) may navigate to a select the desired product. According to some embodiments, the backend system 108 maintains a table of retailers 102 through which it will offer lease-to-own arrangements. Each retail location 102 is associated with a unique identifier such as a key. The datastore 112 contains records identifying each retail location 102 at which the lease-to-own company will provide lease-to-own arrangements, including the name, address, telephone number, email address and geocoordinates of each such retailer 102. Additionally, the datastore 112 contains records associated with each retail location 102, organizing each such retail location's 102 product offerings into categories, subcategories, and so on. The software on the terminal 114 identifies the retail location at which it is operating (example: via the aforementioned retail location identifier or key), and the backend system 112 uses the identifier to retrieve the retailer's 102 product categories (and subcategories) and products associated therewith. The software executing on the terminal 114 responds by presenting a user interface in which the retailer's 102 product offering is organized by category. The product offering presented via the user interface contains only the particular subset of the retailer's 102 product offering that is suitable for leasing via a lease-to-own arrangement. Thus, in the event that the consumer 100 intends to lease a product that is not suitable, he or she will not be able to locate the product at all. The consumer 100 or an attendant representing the lease-to-own company selects the particular product or products intended for lease via the consumer's 100 open-to-lease approval balance. With each such selection, the user is prompted to enter the price of the product. Additionally, with the selection of each product, the user may be prompted to indicate whether the consumer 100 desires to purchase a companion service (example: a warranty for the product).

Upon completion of construction of the order (operation 808), the lease-to-own company's attendant confirms the veracity of the order (operation 810). The attendant confirms that the selections reflect the consumer's 100 desires and that the price inputted for each product correctly states the retail price of each such product. According to some embodiments, the attendant enters a code (such as a password) known only to the attendant to ensure that this confirmation step 810 was performed by the attendant.

Upon being confirmed, the order information constructed in operation 808 is communicated to the backend system 108, such as via a web service exposed by one or more of the processes 120. The backend system 108 responds by returning a selection of payment options by which the consumer 100 may purchase (through a lease-to-own arrangement) the selected products. According to some embodiments, the backend system 108 uses the aggregate price of the selected products (including tax) and number of payments as independent variables, and calculates the amount of each such payment as a dependent variable. Example: six payments of three-hundred dollars, or twelve payments of one-hundred and fifty dollars, or eighteen payments of one-hundred dollars. According to some embodiments, the periodicity of the payments is set equal to the periodicity of the consumer's 100 pay cycle (example: if the consumer 100 is paid bi-weekly, the payment intervals are biweekly, with the actual renewal date being set by the backend system 108 to occur on the same day the consumer 100 is paid). The consumer 100 may be presented with a plurality of payment schedule options from which he or she may select. For example, the consumer 100 may be presented with a range of options wherein the total number of payments may vary from option-to-option, thereby varying the consumer's 100 lease renewal payment amount required at each renewal period. The payment schedule options are presented to the consumer 100, and the consumer 100 selects the particular payment schedule he or she prefers via the terminal 114 (operation 812).

Upon completion of selection of the desired payment schedule (operation 812), an agreement is constructed (operation 814) by which the lease-to-own arrangement is effectuated between the consumer 100 and the lease-to-own company with respect to the selected product or products. The agreement is constructed from a template stored in the datastore 112. The template contains fields, the values of which are determined by the product selection information acquired during operation 808, the payment selection information acquired during operation 812, and from the user account information (name of consumer 100, address of consumer, and so on). According to some embodiments, different forms of the template agreement are stored for each state in the union. The processes 120 cooperate to retrieve the particular template agreement associated with the state in which the retail location 102 is located. The template agreement may contain certain provisions next to which the consumer 100 is required to place his or her initials. According to some embodiments, the software on the terminal 114 drives the consumer 100 to each such location in the agreement and requires the consumer 100 to enter his initials (such as via the terminal's 114 keyboard) to signify understanding and consent to such provision. According to some embodiments, each such provision is extracted and agglomerated into a separate document, and the consumer simply serially initials each such provision. Finally, the consumer 100 signs the template agreement with his full name. The executed agreement is then returned to the backend system for storage in the datastore 112.

Next, in operation 816, the consumer and attendant jointly transact the purchase of the selected product or products at the retail location's 102 native point of sale system 122. According to some embodiments, no payment tender is actually produced during this step 816. Instead, the retailer's 102 point of sale attendant identifies the tender with a code identifying the lease-to-own company. A receipt bearing a unique invoice number is produced by the point of sale system. The invoice number uniquely identifies the sales transaction in the retailer's 102 internal records. The receipt identifies the product as having been purchased via a tender mechanism identifying the lease-to-own company as the purchaser. Thus, although the consumer 100 is in possession of the receipt, he or she cannot use it to return the product to the retailer 102, as the receipt does not identify the consumer 100 as the purchaser of the product or products.

Finally, in operation 818, the attendant and consumer 100 return to the terminal 114, and enter the aforementioned invoice number into the user interface. The invoice number is communicated to and stored in the backend system 108 to associate a particular lease-to-own arrangement with a particular purchase transaction identified by the invoice number. When, at a later date, the lease-to-own company pays the retailer 102 for the product, it may produce a report with one or more invoice numbers therein, so that the retailer 102 may reconcile the payment with the underlying transaction or transactions in its internal records.

To summarize the method of FIG. 8 with reference to FIG. 1, an in-store terminal 114 is used to permit a consumer 100 or an attendant located at the terminal 114 to access the consumer's 100 account and therefore his or her open-to-lease approval balance. Thereafter, sufficient information is entered into the terminal 114 to permit the creation of an agreement effectuating the lease-to-own agreement (i.e., given that the consumer 100 is an already-known individual, product description and price). The attendant verifies the information entered into terminal 114, with particular attention being paid to the product price(s) entered therein to prevent error or fraud. Payment options are presented to the consumer 100 (number of payments, periodicity and timing of such payment, and amounts of such payments), and the consumer 100 selects that which is preferable to him or her. An agreement is then created and executed, reflecting the product information and chosen payment option. Then, the product or products are purchased at the retailer's 102 native POS 122. Finally, the invoice number printed on the receipt generated at the POS is entered into the terminal 114 to form an informational basis by which a particular lease-to-own arrangement can be associated with a particular underlying transaction in the retailer's 102 internal records.

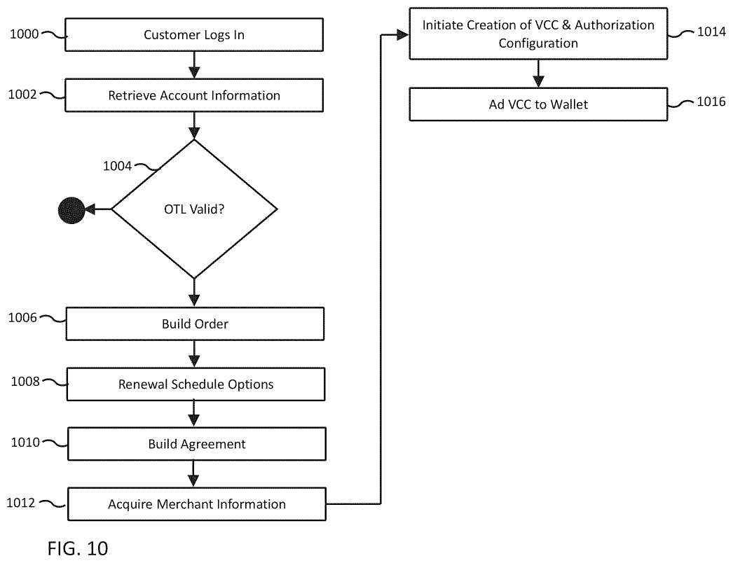

FIG. 10 depicts another embodiment of a method by which the consumer 100 may be provided access to his open-to-lease approval balance, as described with reference to operation 212 in FIG. 2. The method of FIG. 10 is similar to the method of FIG. 8, with certain points of divergence. As an initial matter, the method of FIG. 10 involves a consumer 100 using an app installed on his device 104, as opposed to a terminal 114. Moreover, the method of FIG. 10 does not require the involvement of an attendant, which promotes efficiency.

The method begins with the consumer logging into his or her app, and thereby accessing his or her account data, including the open-to-lease approval balance (operation 1000). Thus, the consumer's 100 account information is accessed via login credentials, as opposed to via an approval code, as was the case in the context of the method of FIG. 8. Thereafter, with one exception, the method of FIG. 10 is identical to that described with reference to FIG. 8, until operational flow reaches operation 1006. Where the method of FIG. 10 is similar to that of FIG. 8, description of the operations is not reiterated in the interest of brevity.

In operation 1006, the consumer 100 constructs his or her order via use of the camera onboard his or her device 104 to scan the barcode of the particular item he or she desires to lease. The barcode information is sent from the app to the backend system 108 for reconciliation into a product description via a global trade identification number such as a UPC, EAN, or ISBN look-up operation. The backend system 108 tests each such selection for suitability in the context of a lease-to-own arrangement, and returns the result to the app for each scanned product. Unsuitable products are not added to the order. Additionally, as part of the order construction process, the consumer 100 is prompted by the app to enter the price information of each such scanned item. Notably, operation 1006 involves the consumer 100 representing to the app and therefore to the lease-to-own company the price of each product he or she desires to lease, and there is no subsequent confirmation step whereby an attendant ensures that the consumer 100 did not misrepresent the price, as is the case in the method of FIG. 8 (see operation 810). Instead, the payment schedule options are presented to the consumer 100 (operation 1008) and the lease-to-own agreement is constructed and executed (1010), in a manner similar to that described with reference to FIG. 8.

According to other embodiments, in operation 1006, the consumer 100 constructs his or her order via use of the camera onboard his or her device 104 to scan a stock keeping unit (SKU) that is visible on the packaging of the particular item he or she desires to lease or on a tag or other surface associated with the item. The SKU may be encoded as a barcode or may be printed as a numeric or alphanumeric sequence or other string. The app may be structured to use barcode reading capabilities native to the operating system of the consumer's 100 portable device 104, or may integrate such capabilities into the code base of the app, itself, such as via linking such capabilities into the code base via a third-party library. In the event that the SKU is printed as a numeric or alphanumeric sequence or other string, the app may use optical character recognition (OCR) capabilities to read the printed sequence or string. As was the case with barcode reading capabilities, the app may be structured to use OCR capabilities native to the operating system of the consumer's 100 portable device 104, or may integrate such capabilities into the code base of the app, itself, such as via linking such capabilities into the code base via a third-party library.

The SKU information is sent from the app to the backend system 108. The SKU information may vary from retailer to retailer for a given item. In other words, although retailer 102 may use a particular SKU to identify a given product, a different retailer may elect to use a different SKU to identify that same given product. Therefore, on a retailer-by-retailer basis, the backend system 108 may store SKU information in a white list maintained in its data store 112. Thus, upon receiving the SKU information, the combination of the retailer's identity along with the SKU information is used to query the data store 112 to determine whether the SKU matches an entry in the white list maintained for the particular retailer offering the particular good that is proposed by the consumer 100 as the subject of a lease-to-own arrangement. If so, the product is deemed a suitable subject for a lease-to-own arrangement, and, conversely, if the SKU does not match an entry in the white list, then the product is deemed unsuitable.

According to some embodiments, the remainder of the order construction process of operation 1006 proceeds as described previously. On the other hand, according to other embodiments, the app is structured to permit the camera onboard the device 112 to be used to read price information (using the OCR capabilities described previously) associated with the product. This has the advantage of reducing the amount of user input required from the consumer 100, and has the further advantage of enhancing the reliability of the price information relating to each good proposed for lease.

At operation 1012, the flow of the method of FIG. 10 diverges from that of FIG. 8. At operation 1012, the identity of the particular retailer 102 that the consumer 100 is located at is acquired. According to some embodiments, the global positioning system (GPS) data onboard the device is accessed and sent to the backend system 108, which responds by querying its datastore 112 with the geocoordinates thereby acquiring a list of all participating retailers within a given proximity of the geocoordinates. The list is returned to the app. In the event that there is more than one such participating retailer, the app constructs a menu and prompts the consumer 100 to select the particular retail location at which he or she is located. The selection is then returned to the backend system 108.

At this point in the operational flow, the backend system 108 is in possession of information pertaining to the aggregate cash price of the selected products and the identity of the particular retailer 102 at which the transaction is to take place. The backend system 108 maintains a database 112 relating each participating retail location with a merchant identifier (MID). An MID is a unit of data that uniquely identifies a given retail location in the context of a payment card transaction. The backend system 108 then performs the following actions in operation 1014: (1) it initiates the creation of a virtual credit card (VCC) that is usable one time to charge a credit transaction to a credit account titled in the name of the lease-to-own company and sends the VCC to the app residing on the consumer's 100 device; and (2) communicates to the authorization platform 110 an information set constituted of the VCC number just issued to the consumer 100, the total price of the transaction, and a timestamp. The authorization platform 110 authorizes credit transactions assessed via the VCC's. The authorization platform 110 adds the information set just received in the context of operation 1014 to a white list. The authorization platform 110 is configured to decline all transactions unless they exhibit a match to an entry in the white list. Thus, the information set contained in an incoming payment card authorization request must match an entry in the white list.

According to some embodiments, a match is declared if the timestamp of the incoming authorization request is within a tolerance of the timestamp of an entry within the white list. This permits a reasonable amount of time to elapse between issuance of the VCC and an attempted use of the VCC. According to some embodiments, a match is declared if the transaction amount of the incoming authorization request is within a certain tolerance in terms of transaction amount of an entry in the white list (thus permitting variances arising from taxes, etc.). The net effect of operation 1014 is to protect the lease-to-own company from potential theft of the VCC by the consumer 100 or from potential misrepresentation of a product's price by the consumer 100. If the consumer 100 were to misrepresent the price of a product or attempt to steal the VCC number and use it in another context, any such use would be declined because the authorization request associated with such unauthorized use would not match an entry in the white list maintained by the authorization platform 110.

Finally, in operation 1016, the VCC is added to the device's 104 “wallet” capability and the consumer 100 is able to conduct payment for the product or products at the retailer's 102 native POS, using the device's 104 native pay-by-phone capabilities.

According to another embodiment of the method of FIG. 10, the lease-to-own company arranges for physical payment cards, such as credit cards, debit cards, open-loop prepaid cards, closed-loop prepaid cards, and so on, to be issued for conducting payments associated with lease-to-own arrangements. For the sake of illustration only, the following exemplary embodiment is described with reference to issuance of credit cards, but those of skill in the art will readily understand that the invention is not so limited. The lease-to-own company may directly issue (for example, if the lease to own company was a bank or otherwise owned a bank) or alternatively arrange for the issuance of credit cards to its customers, such as consumer 100. According to some embodiments, these credit cards are associated with a credit card titled in the name of the lease-to-own company or an affiliate or subsidiary thereof as the primary account holder. Each customer of lease-to-own company, such as consumer 100, is added as an authorized user. Thus, as the primary account holder, the lease-to-own company has responsibility for products properly charged via such credit cards. This structure may ensure the safety and soundness of the issuer, while at the same time avoiding any need for conducting a credit investigation into the creditworthiness of the consumer 100. According to some embodiments, each authorized user, such as consumer 100, is provided with a credit card bearing his or her name and a credit card account number that is uniquely assigned to him or her. According to some embodiments, each customer of the lease-to-own company, such as consumer 100, is issued a credit card (such as via adding each such customer as an authorized user to the lease-to-own company's credit account) in connection with creating the customer's user account in operation 210 of FIG. 2.

According to this alternative embodiment wherein the consumer 100 carries a physical credit card designated for use in connection with lease-to-own arrangements, the consumer 100 is authorized to initiate payment on behalf of the lease-to-own company for products that are the subject of the lease-to-own agreement that was constructed and executed in connection with operation 1010. In using such a credit card in connection with the method of FIG. 10, the structure of the multiparty transaction remains intact: a product is proposed to be leased by the consumer 100, and the lease-to-own company imposes a constraint ensuring that the proposed product is suitable for such a transaction (operation 1006); a lease-to-own agreement pertaining to such product is constructed and executed by the consumer 100 and lease-to-own company (operation 1010); and the lease-to-own company purchases the product and leases the product to the consumer 100 subject to the aforementioned agreement. Notably, the lease-to-own company's payment for the product is initiated by the consumer 100 (in operation 1016, instead of initiating payment via a virtual credit card added to the wallet of the consumer's 100 mobile device, the consumer 100 simply uses the physical credit card designated for this purpose at the point of sale system 122). This eliminates any need for the lease-to-own company to perform the payment as a separate act, and further eliminate the need for the retailer 102 to reconcile the payment with an underlying transaction at the its point of sale system 122.

According to some embodiments, such card transactions initiated by the consumer 100 are subject to authorization in the manner previously described. Thus, in operation 1014, no virtual credit card is issued to the consumer 100 (because the aforementioned physical card is to be used at the point of sale 122 by the consumer 100). However, the backend system 108 communicates to the authorization platform 110 a data set including the credit card number issued to the consumer 100 (or information by which the platform 110 may obtain the credit card number), a timestamp, and a total transaction amount (which may be estimated). The authorization platform adds the information set to a white list, and authorizes the authorization request arising from the consumer's 100 use of the card by virtue of matching the authorization request with the entry in the white list, as described above. Thus, if the consumer 100 were to attempt to use the credit card to initiate any payment other than one associated with buying a product that was the subject of the lease-to-own agreement constructed and executed in connection with operation 1010, the authorization request would be rejected and the lease-to-own company would be safeguarded from such unauthorized and fraudulent use.

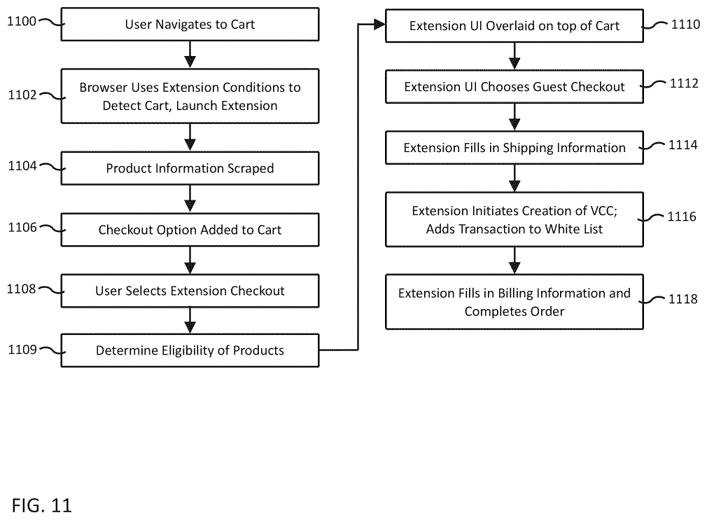

Turning to FIG. 11, another embodiment of a method for providing a consumer 100 access to his or her open-to-lease approval balance (operation 212 of FIG. 2) is depicted. The method of FIG. 11 provides a consumer 100 access to his or her open-to-lease approval balance in the context of online transactions, such as may be transacted via retail websites. Of note, the method of FIG. 11 requires no relationship between the lease-to-own company and the retailer, requires no integration between the systems of the retailer and lease-to-own company, and requires no involvement of lease-to-own company personnel in effectuating a lease-to-own transaction. These are significant points of efficiency.

The method of FIG. 11 initiates at a point in time wherein certain events have previously transpired: the consumer 100 has been shopping on a retail website via a web browser, has identified products he or she desires to lease via a lease-to-own arrangement, has added those products to a shopping cart that is native to the aforementioned retail website, and has navigated to the shopping cart (operation 1100).

At this stage, a previously installed browser extension is launched by the web browser (operation 1102). A browser extension is a unit of code, typically JavaScript, that is launched in a manner that is atypical when compared with the manner by which other units of JavaScript are launched. Typically, when a webpage is navigated to via a web browser, an HTML document is retrieved by the web browser, which then reads the document and responds to the HTML commands therein. Some of the HTML commands therein may contain references to JavaScript files, which causes the web browser to retrieve those JavaScript files and launch them. Thus, JavaScript files that constitute part of the ordinary operations of a website are retrieved and launched because the HTML document that forms the basis of the website contains references to the JavaScript. The unit of code constituting the browser extension, however, contains instructions to the web browser that cause the web browser to launch the extension not because an HTML document contains an explicit reference to the extension, but because a particular web browser event has occurred. According to some embodiments, such instructions are contained in a manifest file and are encoded in a markup language, such as XML. The unit of code (which may include plural files) constituting the extension contains instructions the instruct the web browser to launch the extension when an event associated with navigating to the native shopping cart of a particular retail website occurs. For example, extension may include a manifest file that defines such event to be the web browser having navigated to a universal resource locator (URL) conforming to a pattern defined in the manifest file. Thus, when the consumer navigates to the retail website's native shopping cart, the extension is launched, as depicted in operation 1102. Launching of an extension may not necessarily produce a result that is visible to the user of a web browser, such as consumer 100.

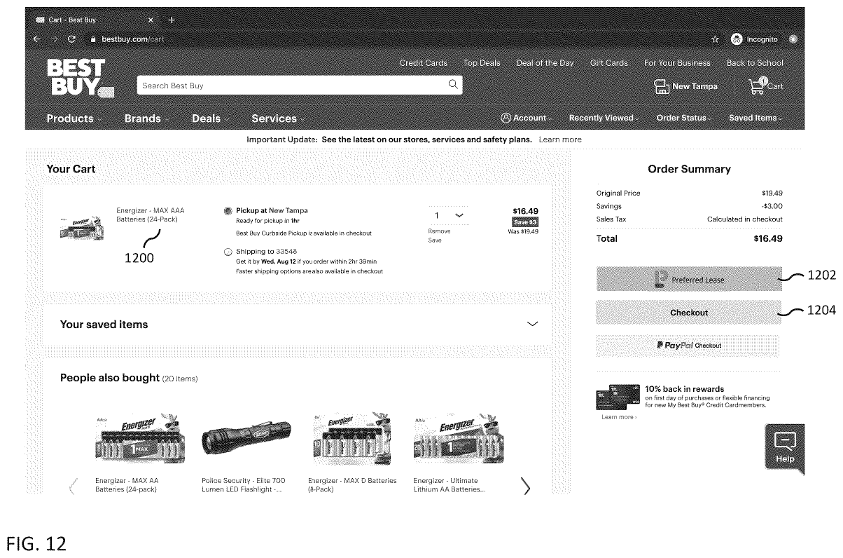

In the wake of having been launched, the extension reads or scrapes the descriptions of the product or products that have been added into the native shopping cart of the retail website (operation 1104). An example of a shopping cart native to a retail website is depicted in FIG. 12. Therein, the product description 1200 that is read or scraped by the extension is visible: “Energizer-MAX AAA Batteries (24-Pack).” At this stage the reader is instructed to suspend his or her critical judgment pertaining to whether or not batteries are the proper subject of a lease-to-own arrangement. As has been discussed, batteries are not the proper subject of such an arrangement, for at least the reason that they are consumable and therefore not amenable to return in substantially the same condition in which they were originally leased to the consumer 100. The discussion of the method of FIG. 11 will progress in large part as though these batteries may be leased via a lease-to-own arrangement solely for the purpose of illustration of the method.

In operation 1106, a selectable element (such as a button) associated with a checkout path by which the consumer 100 may lease the products in the cart via a lease-to-own relationship is added to the shopping cart by the extension. For example, in FIG. 12, button 1202 has been added to the shopping cart-had the consumer 100 accessed the retail website via a web browser that did not have the extension installed, the aforementioned button 1202 would not appear, as it is not coded for in the code (i.e., the combination of HTML, Javascript and CSS) that makes up the retail website. The consumer 100 may initiate leasing of the products in the cart, (AAA batteries in the context of this example) by selecting, clicking or tapping the button 1202 (operation 1108).

In the wake of the consumer 100 clicking the button 1202, the extension communicates with the backend platform 108 (operation 1109). The datastore 112 of the backend platform 108 contains records associated with each online retailer with which the extension is interoperable. (The extension is interoperable with a given online retailer if it is coded to instruct the web browser to launch the extension in response to the web browser having been navigated to the retailer's shopping cart.) These records reflect, on a retailer-by-retailer basis which particular products are suitable for leasing via a lease-to-own arrangement. Thus, they constitute a whitelist. Conceptually, then, the records are structured thusly:
{(retailer identifier, product description1), (retailer identifier, product description2), . . . (retailer identifier, product descriptionn)}, or
{(retailer identifier, product description1, identifier1), (retailer identifier, product description2, identifier2), . . . (retailer identifier, product descriptionn, identifiern)}.

Upon the consumer 100 clicking the button 1202, the extension communicates with the backend system 108, identifying the retailer and the product or products that the consumer 100 has added to the cart. The backend system 108 responds by examining each such product for inclusion in the whitelist. For example, one or more processes 120 may query the datastore 112 to determine whether it includes in its whitelist a given product description or product identifier (example: UPC code, EAN code, ISBN code, model number, etc.) associated with the particular retailer at which the consumer is shopping, and the backend system 108 may respond by identifying to the extension all products that are not in the whitelist. Thus, an empty data set would indicate that all of the products are suitable for leasing.

In the event that a the extension received a response from the backend 108 indicating that a particular product in the shopping cart was ineligible for leasing, the extension would present a message indicating that fact to the consumer 102, and instruct the consumer 100 to remedy the situation, such as by removing the ineligible product from the shopping cart (operation 1110).

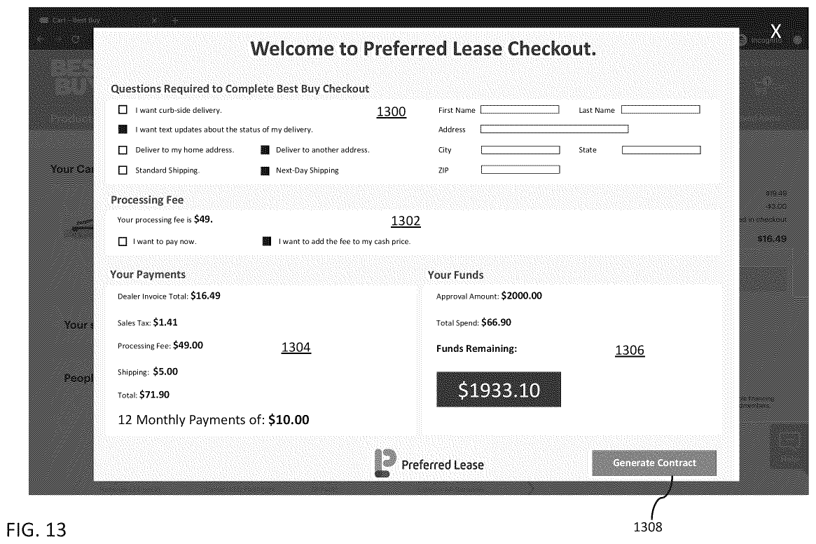

On the other hand, if the extension received a response from the backend 108 indicating that all of the products in the shopping cart were eligible for leasing, the extension would overlay a different user interface over the shopping cart, such as the one depicted in FIG. 13.

The purposes of the user interface presented in operation 1110 are: (1) to collect from the consumer 100 sufficient information to permit the extension to complete the checkout process on behalf of the consumer 100; and (2) guide the consumer 100 through the presentation and execution of a lease-to-own agreement by which the lease-to-own company agrees to buy the product or products in the cart on behalf of the consumer 100 and lease them to the consumer 100, and by which the consumer 100 agrees to lease the product or products pursuant to certain terms. As can be seen from FIG. 13, the user interface includes user input fields and elements that collect the information from the consumer 100 required for completion of the native checkout process of the retail website. This is discussed in more detail below.

According to some embodiments, the user interface contains a section 1302 that permits the consumer 100 to choose between immediately paying a processing fee relating to the establishment of the lease-to-own arrangement, or rolling the fee on to the cash price of the product or products to be leased. Additionally, the user interface may include a section 1304 summarizing the financial terms of the agreement. Finally, the user interface may include a section 1306 representing the effect of the potential lease-to-own arrangement on the consumer's 100 open-to-lease approval balance, including representing the amount of open-to-lease funds the consumer 100 will available if he or she in fact executes the agreement. Should the consumer 100 find the information in sections 1304 and 1306 acceptable, he or she may click button 1308 in order to initiate generation of the lease-to-own arrangement.

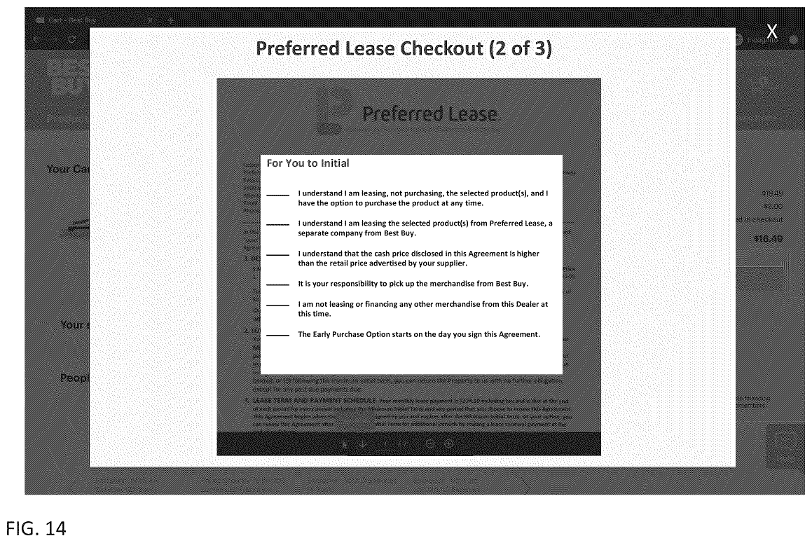

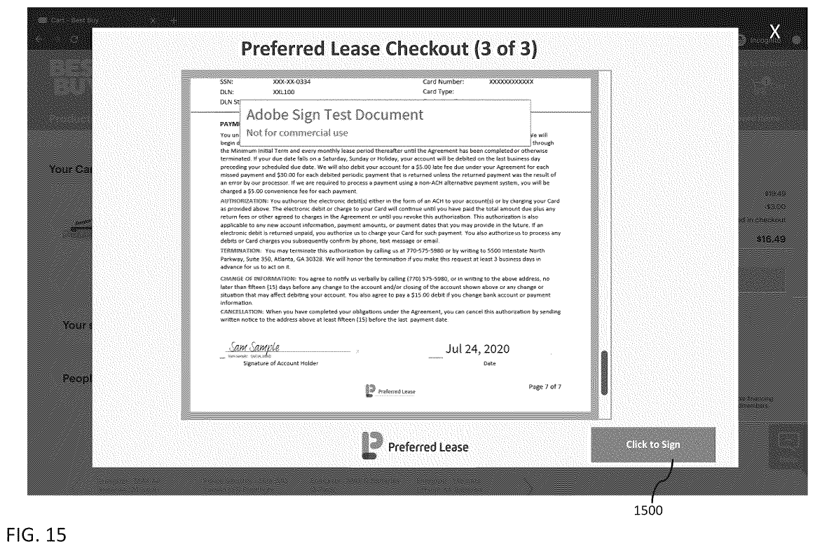

The lease-to-own agreement is constructed based upon information read or scraped from the website (example: product description, product price), information collected about the consumer 100 during the process of account creation (example: consumer 100 name and address), and information collected via the user interface of the extension (example: selected shipping method which influences price). Although the means by which the information used in connection with generating the agreement is different in the context of the present method than in the context of the method of FIG. 8, the process of generating the contract, itself, has been described with reference to operation 814 of FIG. 8, and for the sake of brevity is not repeated here. The extension continues its user interface overlay operation (operation 1110) by presenting the consumer 100 with the constructed lease-to-own agreement pertaining to the product or products in the shopping cart. As shown in FIG. 14, the consumer is guided through initialing certain contract provisions from the agreement, as discussed previously in connection with FIG. 8. Next, as shown in FIG. 15, the consumer 100 is permitted to view the agreement and to execute the agreement by selection of button 1500.

In the wake of operation 1110, the extension fills in the various web pages constituting the checkout flow of the retail website, using the information it read or scraped along with the information acquired from the consumer 100 via the user interface, such as the interface depicted and described with reference to FIG. 13. For example, consider a retail website that, after selection of the native checkout option by the consumer 100, flows the consumer through the following steps: (1) prompt the consumer to select from amongst a membership checkout path or a guest checkout path; (2) prompt the user for shipping information (delivery address, shipping method, preferred delivery status update methods, etc.; and (3) prompt the user for billing information, and request the user to complete the order. In such an example, the extension may keep its user interface overlaid atop the retail website's native shopping cart and checkout pages, while the extension programmatically fills out these pages on behalf of the consumer 100. For example, the extension may programmatically select a guest checkout flow (operation 1112), and thereafter fill in the shipping information based upon the information acquired from the consumer 100 via the user interface of FIG. 13, or based upon the information acquired about the consumer 100 during his or her account creation process (operation 1114).

Next in operation 1116, the extension interoperates with the backend system 108 to initiate the creation of a one-time use VCC, and add the imminent transaction to a whitelist maintained by the authorization engine 110. Details relating to these actions of operation 1116 were presented previously herein with reference to FIG. 10, and for the sake of brevity are not repeated here.

Finally, in operation 1118, the extension fills in the billing information using the VCC and programmatically clicks the button that the consumer 100 would ordinarily click on the native checkout page to complete the order.

According to some embodiments, a credit card number associated with a credit card issued to the consumer 100 for the purpose of initiating payments on behalf of the lease to-own company is used in connection with the method of FIG. 11, as opposed to a virtual credit card. Topics pertaining to issuance of such a card have been previously discussed with reference to FIG. 10, and are not reiterated here. According to these embodiments, no VCC is created in connection with operation 1116, although addition of a data set describing the impending transaction to a white list maintained by the authorization platform 110 is conducted in operation 1116. Finally, the extension may optionally inject the card number to the into the native checkout page, as a part of operation 1118. According to some embodiments, this step is performed the consumer 100.

The net result of the operations of FIG. 11 is that the extension manages the processes of determining whether the products selected for leasing via a lease-to-own arrangement are suitable, further manages the processes of agreement creation, presentation and execution, and then automatically conducts the process of purchasing the product and having it delivered to the consumer 100 (or to an address of the consumer's 100 choosing). These processes are initiated via a button that appears as though it is natively a part of the retailer's website, and via user interfaces that also appear as though they are natively a part of the retailer's website. The entire lease-to-own arrangement may be effectuated by the consumer 100 without the consumer navigating away from the retail website to conduct other operations or acquire other information, and without the consumer 100 having to open another window or tab within his or her web browser. All of these facets of the extension and the process it enables are points of efficiencies.

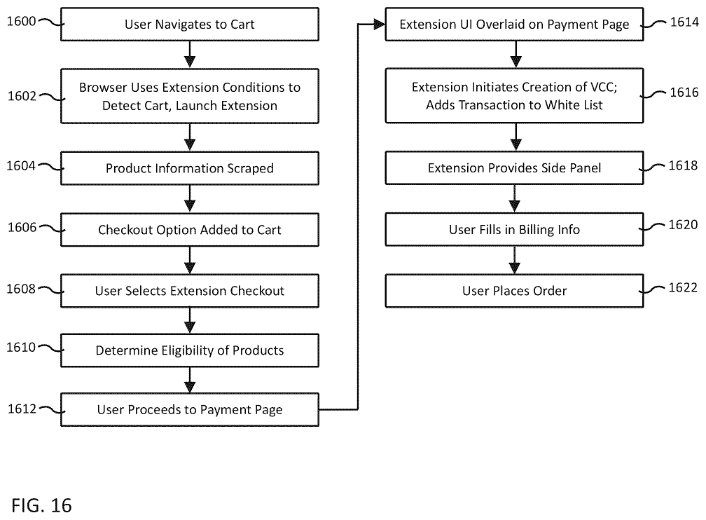

Turning to FIG. 16, another embodiment of a method for providing a consumer 100 access to his or her open-to-lease approval balance (operation 212 of FIG. 2) is depicted. Like the method of FIG. 11, the method of FIG. 16 provides a consumer 100 access to his or her open-to-lease approval balance in the context of online transactions, such as may be transacted via retail websites. Also like the method of FIG. 11, the method of FIG. 16 requires no relationship between the lease-to-own company and the retailer, requires no integration between the systems of the retailer and lease-to-own company, and requires no involvement of lease-to-own company personnel in effectuating a lease-to-own transaction. These are significant points of efficiency.

The method of FIG. 16 initiates at a point in time wherein certain events have previously transpired: the consumer 100 has been shopping on a retail website via a web browser, has identified products he or she desires to lease via a lease-to-own arrangement, has added those products to a shopping cart that is native to the aforementioned retail website, and has navigated to the shopping cart (operation 1600). The method of FIG. 16 is identical to the method of FIG. 11 until operational flow reaches operation 1610 (determining the eligibility of the product or products added to the shopping cart for leasing via a lease-to-own arrangement). At this point, there is some divergence between the two methods. The mechanism for determining eligibility of the product or products is identical to that described with reference to FIG. 11 and for the sake of brevity is nor reiterated here. Moreover, the actions of the extension in the event that the response from the backend platform 108 indicates that one or more products in the shopping cart are ineligible for leasing are also identical to those described with reference to FIG. 11, and therefore are not reiterated here. However, in the event that each of the products in the shopping cart are eligible for leasing, then the extension programmatically selects the retail website's native checkout button 1204. Thus, the consumer 100 is presented with the next native screen in the native checkout process. The consumer 100 proceeds to fill in each screen constituting the native checkout process of the retail website until such time that the native payment page or billing information page is reached (operation 1612).

The net effect of requiring the consumer to manually fill the native checkout pages leading up to the native payment page or billing information is that points of dependency between the extension and the retail website are reduced. In fact, the process of FIG. 16 exhibits no dependence whatsoever on the structure or informational content of the pages interposed between the initial shopping cart page from which the product information is read or scraped (example: the page depicted in FIG. 12) and the native payment page or billing information page. Moreover, as discussed below, the method contains no dependence on the structure or informational content of the native payment page or billing page either. The result is that the operation of the extension is less likely to be interfered with as a consequence of any changes that may occur to the retail website's native shopping cart pages.

When the consumer reaches the native payment page or billing information page, the extension superimposes its user interface over such page (operation 1614). Initially, the extension drives the consumer 100 through the lease creation, presentation and execution process in a manner similar to that described with reference to FIG. 11. Thus, the consumer 100 is presented with user interface screens such as the examples depicted in FIGS. 14 and 15 (the user interface screen of FIG. 13 is unnecessary in this flow). Details pertaining to constructing the lease agreement, presenting it to the consumer, and having it executed have been described with reference to FIG. 11 and are not reiterated here.

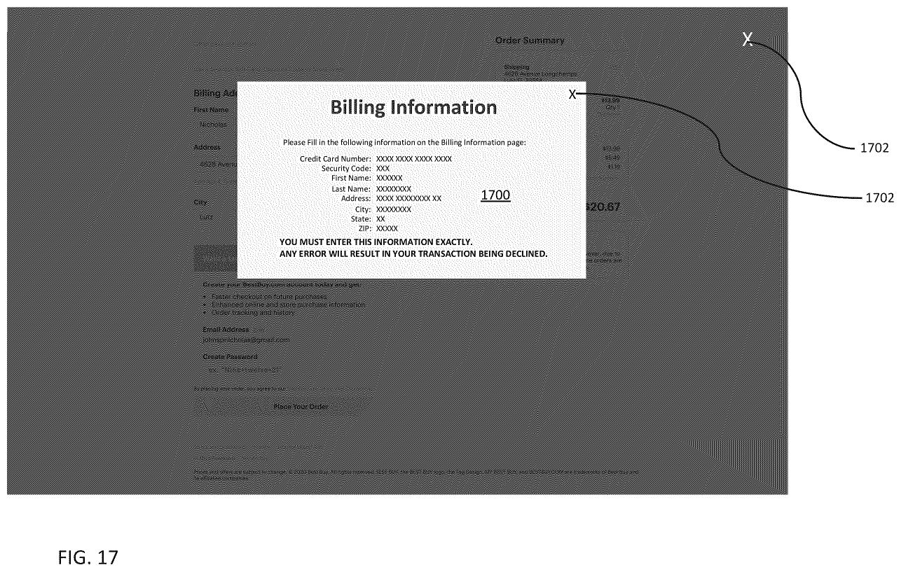

When the consumer 100 selects the button 1500 designated for execution of the lease-to-own agreement, the extension responds in two ways. First, in operation 1616, the extension initiates the creation of a VCC that is usable for a single transaction, and adds the aforementioned transaction to the whitelist maintained at the authorization platform 110. These processes have been discussed previously and are therefore not discussed here. Next, in operation 1618, the extension presents a side panel, initially superimposed over the native payment page or billing information page. An exemplary embodiment of the side panel 1700 is depicted in FIG. 17.

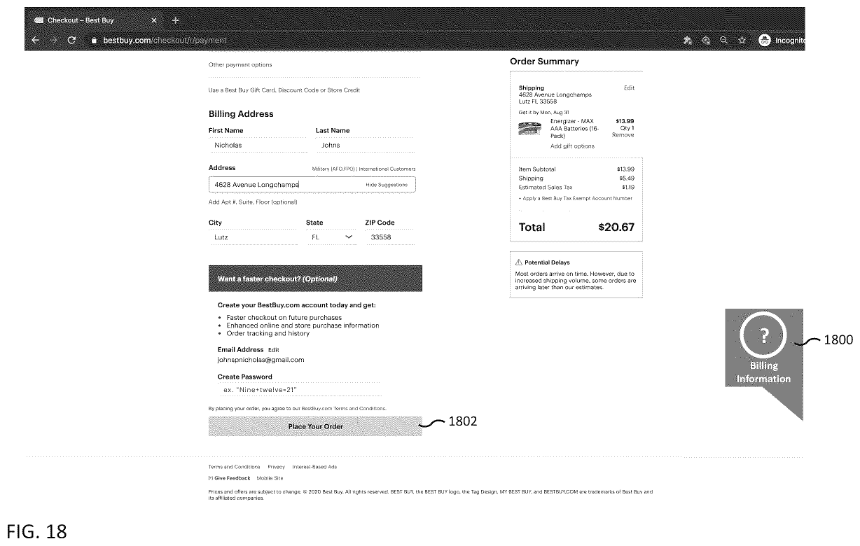

As can be seen from FIG. 17, the side panel 1700 presents to the consumer 100 the information that the consumer 100 is to enter into the native payment page or billing information page, including the VCC information. The side panel further 1700 further informs the consumer that if this information is not entered into the native payment page or billing information page faithfully, the transaction will be declined. The consumer 100 closes the side panel 1700 (by pressing either close button 1702) and enters the billing information from the side panel 1700 into the native payment page or billing information page (operation 1620). To assist the consumer 100, the side panel 1700 may remain accessible to the consumer 100 via the side panel button 1800, as shown in FIG. 18. In response to the selection of the side panel button 1800, the side panel 1700 is presented once again to the consumer 100, so that he may copy information therefrom or otherwise refresh his or her memory concerning its contents.

When the consumer 100 has completed the task of manually entering the billing information into the native payment page or billing information page, the consumer 100 places his or her order by selecting the native button 1802 assigned for that task (operation 1622). Should it be the case that the information entered into the native payment page or billing information page is not the same as that presented on the side panel 1700, the authorization request will be declined because the information in the authorization request will not match an entry in the whitelist maintained on the authorization platform 110. In the event that the discrepancy was the product of accident, the consumer 100 will be able to re-enter the information and try to initiate the transaction again. In the event the discrepancy was intentional, perhaps as a result of the consumer 100 trying to intercept the VCC account number for use elsewhere, the result will be that the VCC will not be useful to conduct any other transaction than the particular transaction recorded in the whitelist at the authorization platform 110. Thus, no fraud is possible.

According to some embodiments, a credit card number associated with a credit card issued to the consumer 100 for the purpose of initiating payments on behalf of the lease to-own company is used in connection with the method of FIG. 16, as opposed to a virtual credit card. Topics pertaining to issuance of such a card have been previously discussed with reference to FIG. 10, and are not reiterated here. According to these embodiments, no VCC is created in connection with operation 1616, although addition of a data set describing the impending transaction to a white list maintained by the authorization platform 110 is conducted in operation 1616. Finally, the user enters the card number to the into the native checkout page, as a part of operation 1620.

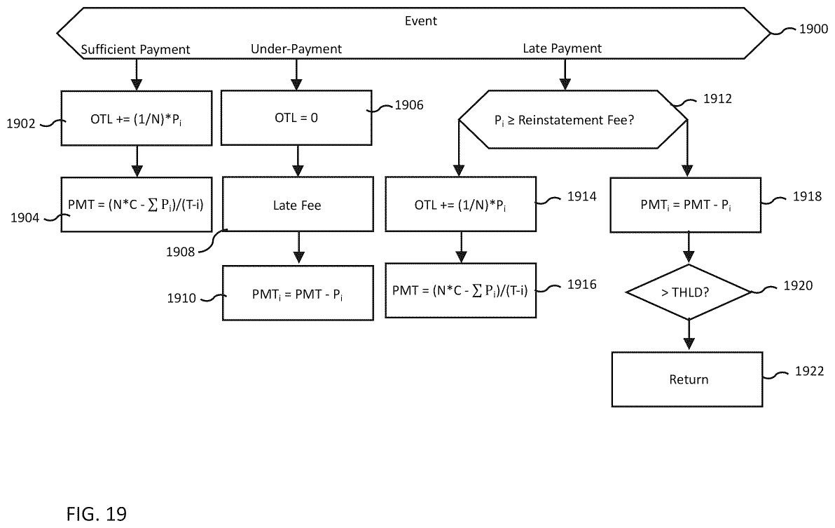

FIG. 19 depicts a method by which consumer 100 accounts may be managed by the backend system 108. The processes 120 executing on the backend system 108 interact with the datastore 112 to conduct the operations of FIG. 19.

By way of introduction to the operations of FIG. 19, according to some embodiments, the lease-to-own arrangements agreed upon by the consumer 100 and the lease-to-own company extend for a defined period (example: a period of one month). At the conclusion of the period, the consumer 100 may elect to renew the lease by making a renewal payment, whereupon the lease arrangement is continued or renewed for another period. Alternatively, the consumer 100 may elect to return the leased product and thereby terminate the lease-to-own arrangement. Should it be the case that, as of the conclusion of a given period, referred to as a scheduled renewal date, the consumer 100 has neither made a renewal payment nor returned the product, the lease-to-own arrangement may expire. Should the lease-to-own arrangement expire, the consumer 100 may reinstate the arrangement by paying a reinstatement fee, either with or without an intervening grace period, whereupon the lease-to-own arrangement continues on for another period in the manner just described. Should the consumer 100 elect to make an agreed upon number of renewal payments, i.e., elect to lease the product for an agreed upon number of periods, then at the conclusion of the final period, title to the product passes to the consumer 100. The operations of FIG. 19 cooperate to manage a consumer's 100 account to accord with this agreed upon lease-to-own arrangement.

The method depicted in FIG. 19 is driven by consumer 100 account events. In operation 1900, an event declaratory engine determines and declares that an event of a particular variety has occurred. For example, in operation 1900, a sufficient payment event may be declared. This particular variety of event can be declared at any point in time that is prior to, or contemporaneous with, the particular date on which payment is to have been made by a consumer 100 in respect of a particular lease-to-own arrangement, i.e., a scheduled renewal date. For example, if a particular lease-to-own arrangement calls for monthly payments of $150 to be made on the 15th of each month for a succession of twelve months, then a sufficient payment event can be declared on the 15th of a particular month during the term of the arrangement, or at any time prior thereto. A sufficient payment event is declared if the consumer 100 has made payments that in aggregate are equal to or greater than the renewal payment amount agreed to by the consumer 100 and the lease-to-own company in the lease-to-own arrangement (as may be adjusted from time to time). Typically, the consumer 100 makes only one such payment. For example, continuing on with the example wherein $150 is due on the 15th of each month, the consumer 100 may be generally make a single payment of $150 on the 15th of the month. In that event, a sufficient payment event would be declared on the 15th of the month. On the other hand, the consumer 100 may make plural payments in advance of the 15th. For example, consider the example wherein the consumer 100 makes a first payment of $50 on the 10th of the month and then makes a second payment of $150 on the 12th of the month. In such a scenario, the consumer 100 will have made an aggregate payment of $200 (which, pursuant to the example, is more than is required) on the 12th of the month. In this case, a sufficient payment event is declared on the 12th.

According to some embodiments, when a sufficient payment event is declared, the consumer's 100 open-to-lease approval balance is restored as a consequence. Consider a scenario wherein the consumer 100 and lease-to-own company agree upon a lease-to-own agreement wherein the aggregate payment amount due under the contract is equal to a multiple, N, multiplied by the aggregate cash price of the products, C, leased under the contract. Thus, the total amount due under the contract is expressed as:

Total Contract Amount=(N*C).

Consider further that the lease-to-own agreement calls for a quantity of T payments. The renewal payment amount, PMT, under the contract is therefore expressed as:

PMT=(N*C)/T.

Continuing on with the previously stated example wherein the consumer 100 made aggregate payments totaling $200 on the 12th, let us further assume that such payments were made in respect of the first scheduled renewal date. The payments are collectively referred to as P₁. Thus, P₁=$200. As a general matter, the aggregate amount paid by a consumer 100 in respect of the i^{th} scheduled renewal date is referred to as P₁.

As shown in operation 1902, the consumer's 100 open-to-lease approval balance is increased by a quantity equal to the reciprocal of the contract's multiple, N, multiplied by the aggregate payments made in respect of the first scheduled renewal date, P₁:

Open-to-Lease Approval Balance New=Open-To-Lease Approval Balance old+(1/N*P₁).

In addition to adjusting the consumer's 100 currently available open-to-lease approval balance in consideration of a sufficient payment event, the consumer's 100 agreed upon renewal payment amount may be adjusted in view of the payment. (The adjustment set forth below will not result in any change in the consumer's 100 renewal payment amount, if the consumer's 100 aggregate payments in respect of a scheduled renewal date is equal to the renewal payment amount.).

In operation 1904, the consumer's 100 new renewal payment amount is calculated as the total contract amount, less the aggregate of payments made by the consumer 100, divided by the remaining quantity of payments specified under the contract:

PMT=[(N*C)−ΣPi]/(T−i),
where i is an ordinal representing the particular scheduled renewal date that the declared sufficient payment is in respect of. For example, if a consumer's 100 aggregate payments were declared to constitute a sufficient payment event in respect of the contract's third required payment, i=3.

According to some embodiments, and as an alternative to operation 1904, in the event that the consumer 100 made one or more payments in respect of a particular scheduled renewal date, the aggregate of which exceeded the renewal payment amount, the residual portion of the payment is applied to the next scheduled renewal date, resulting in the renewal payment amount corresponding to that date to be reduced by the aforementioned residual portion. According to some embodiments, absent consumer 100 instruction, the method of FIG. 19 defaults to applying the residual portion of an overpayment equally among all remaining scheduled renewal date, thereby generally reducing the renewal payment amount, as discussed with reference to operation 1904. On the other hand, should the consumer 100 provide instruction to apply the residual portion to the next scheduled renewal date, then the residual is so applied, as just discussed.

Returning to operation 1900, the event declaratory engine may determine that an underpayment event has occurred. An underpayment event can only be declared on a scheduled renewal date. If, on a particular scheduled renewal date, the consumer's 100 aggregate payments in respect of such scheduled renewal date are less than the required renewal payment amount, an underpayment event is declared.

According to some embodiments, in response to a declaration of an underpayment event, the consumer's 100 open-to-lease approval balance is suspended (operation 1906). Thereafter, a late fee may be added to the consumer's 100 next required payment to reinstate the lease-to-own arrangement (operation 1908). Finally, in operation 1910, the consumer's 100 current reinstatement payment amount, PMTi, is reduced by the aggregate of payments made by the consumer 100 in respect of the current scheduled renewal date:

PMTi=PMT−Pi.

Consider that the consumer 100 owed $150 as a contractually obligated payment to renew the lease, and consider further that the consumer 100 had, as of the scheduled renewal date, made an aggregate of $25 in payments in respect of such contractually-obligated payment. In such a scenario, the combined effects of operations 1906-1910 would be to: (1) suspend the consumer's open-to-lease approval balance; (2) after expiration of any applicable grace period, add a late fee to the consumer's 100 next required payment to reinstate the lease-to-own arrangement; and (3) adjust the consumer's 100 account to reflect that the consumer 100 currently owes a reinstatement fee equal to the sum of the late fee and $125. According to another embodiment, if, as of a scheduled renewal date, the aggregate payments made by a consumer 100 are insufficient to renew the lease, the backend system 108 does not apply the consumer's 100 payment to his or her account, and either applies a refund or holds the funds for application upon reinstatement.

Returning once more to operation 1900, the event declaratory engine may determine that a late payment event has occurred. A late payment event can only be declared upon the receipt of a payment from a consumer 100 after a scheduled renewal date, and only if immediately preceded by the declaration of an underpayment event.

In the event of declaration of a late payment event, it is determined whether the aggregate of the consumer's 100 late payments made in respect of the scheduled renewal date is equal to or in excess of the reinstatement fee (which may or may not include a late fee added thereto). If so, then the consumer's 100 open-to-lease approval balance is restored and adjusted (operation 1914) and the consumer's renewal payment amounts are adjusted (operation 1916). Operations 1914 and 1916 have been described previously with regard to operations 1902 and 1904, and in the interest of brevity are not described again. Finally, the declaration of the late payment event is withdrawn.

In the event that the residual amount of the consumer's 100 late payment is less than the reinstatement amount, then operational flow is passed to operation 1918. In operation 1918, the consumer's 100 reinstatement amount is reduced by the amount of the consumer's 100 late payment. Finally, it is tested to determine whether a quantity of days greater than a threshold have elapsed (operation 1920). If so, the customer may be required to return the product or products identified in the lease-to-own agreement (operation 1922), and the backend system 108 may initiate contact with the customer to arrange for the return.

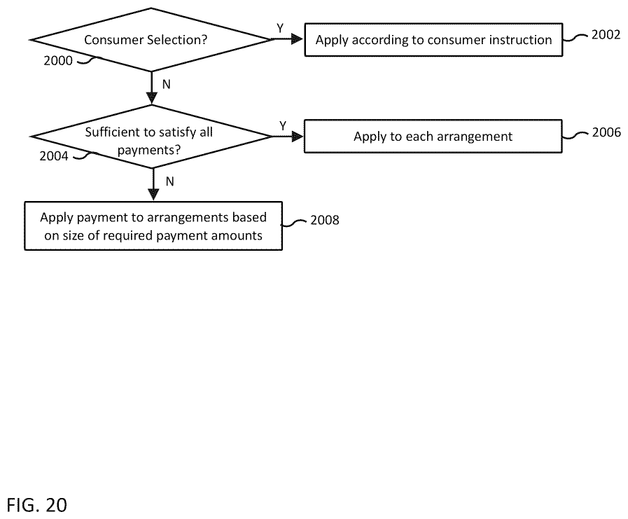

The events declared in operation 1900 are initiated in response to application of a consumer's 100 payment to a particular lease-to-own arrangement recorded in the consumer's 100 account. In the event that the consumer 100 has plural lease-to-own arrangements recorded in his or her account, a decision must be made by the backend system 108 concerning to which particular lease-to-own arrangement to apply a given payment. FIG. 20 depicts a method by which the backend system 108 may apply a payment to individual lease-to-own arrangements, in the event that a consumer 100 has plural lease-to-own arrangements recorded in his or her account. The processes 120 executing on the backend computing platform 108 access the datastore 112 to update the records constituting the consumer's account, in order to perform the operations depicted in FIG. 20.

According to some embodiments, the consumer 100 is provided the opportunity to provide instructions pertaining to which particular lease-to-own arrangements to which he or she wants a payment applied. For example, if the consumer 100 is paying via the aforementioned app or a website, the app or website may have a user interface presenting to the consumer 100 the various active lease-to-own arrangements recorded in his or her account, along with the next upcoming scheduled renewal date and contractually-required payment amount for each such arrangement. The consumer 100 may select which of the lease arrangement he intends a given payment to be applied to, along with an indication of how the particular payment should be apportioned among the selected arrangements. (Example: the consumer 100 may make a payment of $300, and indicate that $100 is to be applied to lease-to-own arrangement #1, with the remaining $200 being applied to lease-to-own arrangement #3, while applying none of the payment to lease-to-own arrangement #2.) In operation 2000, it is determined whether the consumer 100 has, in fact, provided instructions specifying the manner in which his or her payment is to be applied. If so, then the payment is applied to the consumer's various lease-to-own arrangements as determined by the consumer's 100 instructions (operation 2002). On the other hand, if the consumer did not provide instructions, then operational control is passed to operation 2004.

In operation 2004, it is determined whether the payment is sufficient to satisfy each of the consumer's 100 outstanding upcoming contractually-required payment amounts. If so, then the payment is applied to each such arrangement (operation 2006). In the event that, in the wake of applying the payment, there is a residual amount, the amount is applied to particular lease to own arrangement that, after application of the payment would result in the smallest adjusted contractually-required payment. For example, assume a consumer 100 made a payment that, in the wake of application to two lease-to-own arrangements resulted in a residual amount of $100. Further assume that, if the residual amount were applied to the consumer's 100 first lease-to-own arrangement, that arrangement would then call for an adjusted payment of $55 per payment period, while if the residual amount were applied to the consumer's 100 second arrangement, that arrangement would then call for an adjusted payment of $95 per payment period. Pursuant to operation 2006, the residual amount should be applied to the consumer's first lease-to-own arrangement, as a consumer 100 protection measure. Such application puts the consumer 100 in the position of having to produce the least amount of cash on a per-payment-period basis to avoid expiration of at least one arrangement.

Finally, if the payment is insufficient to satisfy each of the consumer's 100 outstanding upcoming contractually-required payment amounts, then the payment is initially applied to the particular outstanding arrangement with the smallest payment sufficient to renew the lease-to-own agreement. Thereafter, any residual amount is applied to the particular outstanding arrangement with the next-smallest required payment. This method of payment application pursuant to operation 2008 is repeated until no residual amount remains. The purpose of this application method is to protect the consumer 100: it ensures that the fewest number of lease-to-own arrangements incur reinstatement fees or otherwise enter a state of expiration.

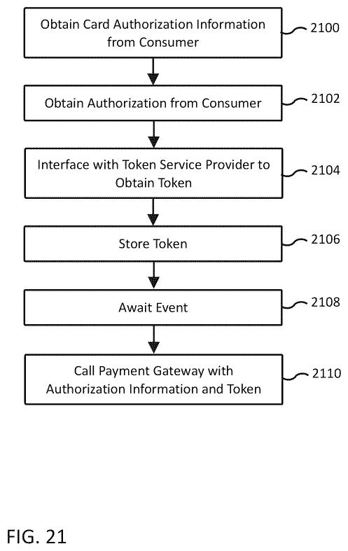

Discussion now turns to FIG. 21. The method of FIG. 21 assumes that the lease-to-own company accepts card payments, such as those that may originate from the consumer 100. Therefore, according to some embodiments, the lease-to-own company has formed a relationship with an acquirer and processor by which it is sponsored into various payment networks (example: MasterCard, Visa, etc.) as a merchant so that it can interoperate with those payment networks to initiate card payments and receive funds resulting from those payments.

FIG. 21 depicts an embodiment of a method for holding a consumer's 100 payment card on file. In principle, the payment card could be of any variety (example: credit card, debit card, open-loop prepaid card, close-loop prepaid card, etc.), but for the sake of illustration, the card will be referred to as a credit card in this discussion pertaining to FIG. 21.

The method of FIG. 21 is performed by the backend system 108, including its processes 120 and data store 112, in cooperation with a computing device to which the consumer 100 has access and which is in communication the backend system 108, such as the consumer's 100 portable device 104 or computer 116, or a terminal 114 located at the retailer 102. In other words, some portions of the method of FIG. 21 may be carried out by a lease-to-own app (or, alternatively, a web browser) installed on the consumer's 100 portable device 104 or computer 116, or by the aforementioned terminal 114. Moreover, some portions of the method of FIG. 21 may be carried out by the backend system 108.

The method of FIG. 21 begins with obtaining credit card authorization information from the consumer 100 (operation 2100). For example, in connection with the user account creation process of operation 210 of FIG. 2, the consumer 100 may be prompted for his credit card authorization information, which includes a credit card number, an expiration date thereof, and a security code associated therewith, along with other information that would have already been collected in the context of the process of FIG. 2 (example: the consumer's name, street address and telephone number). The consumer 100 is also prompted for his authorization to store his credit card on file for future use that he or she authorizes (operation 2102).

After receiving authorization from the consumer 100, the backend system 108 interfaces with a token service provider (not depicted) to initiate the creation of a token to serve as a surrogate for the consumer's 100 credit card number (operation 2104). According to some embodiments, the backend system 108 may structure its communication with the token storage provider so as to request that the token returned by the provider is subject to a domain restriction such that the token will be usable only in connection with card payments initiated by the backend system 108. The token service provide responds by returning such a token.

In operation 2106, the token is stored in association with the consumer's 100 user account. According to some embodiments, the token is stored in the data store 112 in the backend system 108. According to other embodiments, the token is stored by a third-party service provider that may handle token operations on behalf of the lease-to-own company.

In operation 2108, the occurrence of an event that gives rise to an occasion to initiate a charge to the card-on-file for the consumer 100. For example, in operations 812, 1008, 1110 and 1614, the consumer 100 may be prompted to determine whether he or she prefers that a processing fee associated with establishment of the lease-to-own arrangement be: (1) added to the cash price of the product that is the subject of the arrangement, and therefore paid for over the course of the arrangement; or (2) paid for by the consumer 100 immediately. In the event that the consumer 100 elects to pay for the processing fee immediately, a payment transaction in the amount of the processing fee is initiated by the backend system 108 using the token as a surrogate for the consumer's credit card number (operation 2110). According to some embodiments, the initiation of the payment transaction may be conducted indirectly, such as by interfacing with a third-party system, such as a system of the variety discussed with reference to operation 2106, which, in turn, may interface with a payment gateway.

Other events may give rise to an occasion to initiate a charge to the card-on-file for the consumer 100. For example, any payment operation referred to in reference to FIG. 19 may be conducted via the consumer's 100 card-on-file. Additionally, should it be the case that a set of products proposed as the subjects of a lease-to-own arrangement contain a product that is unsuitable for such an arrangement, such a product could be removed from the arrangement and paid for via the consumer's 100 card-on-file.

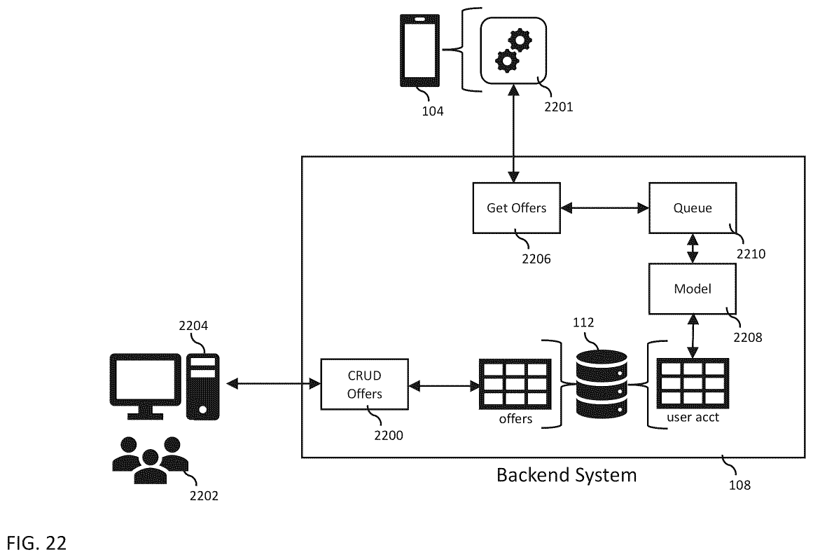

Turning to FIG. 22, the system depicted therein assumes that an app 2201 published by a lease-to-own company, such as app 300 with exemplary user interfaces depicted in FIGS. 4-7 and 9, is structured to contain a wallet. A user of the app 2201, such as the consumer 100, encounters the wallet as a region of the user interface of the app 2201 that stores units of information that is of use to the user in connection with his or her use of the app 2201. For example, the wallet may store units of data that represent offers from retailers, such as retailer 102, wherein the retailer 102 is offering to reduce the price of a particular product or category of products, in response to the user demonstrating to the retailer 102 that his or her wallet contains the retailer's 102 offer. A typical scenario may involve a user of the app 2201 accessing the wallet and seeing that the retailer 102 is offering to reduce the retail price of a particular category of products for that user (example: 20% off of home theater equipment). Assuming the user elects to act on the offer, the user may purchase home theater equipment at the physical retail location 102 extending the offer take advantage of the price reduction. While at the POS system 122 effecting a rent-to-own transaction as described herein previously, the user may access the wallet and show the POS attendant the relevant offer therein, causing the attendant to initiate the price reduction via the POS. Alternatively, the user may visit the retailer's website to purchase home theater equipment. During the checkout process, the user may indicate that the purchase is subject to an offer, and enter a promotional code contained in the offer, in order to obtain the price reduction.

The wallet may contain plural offers. For example, plural offers may be presented as a succession of tiles that are accessible via the wallet region of the app's user interface. Each tile may correspond to a single offer, and the user may view the offers by swiping the screen of the user's portable device 104 to control which particular tile is visible within the viewable area of the wallet. In summary, the offers are organized in a set or list, wherein the first or top member of the set is immediately accessible or visible by the user, and wherein each successive member of the set is accessible or viewable in response to the user navigating (such as via swiping a screen) further down the set or list. Consequently, offers situated at the top of the set are more likely to be seen by the user.

The data constituting the offers is stored in the data store 112 of the backend system 108. According to some embodiments, the backend system 108 executes processes 2200 that may be used to introduce a set of data constituting a new offer into the data store 112. The processes 2200 also permit updating, retrieving and deleting the offer. The capabilities of the processes 2200 may be exposed as one or more application interfaces (API's) via endpoints so that offers may be created, retrieved, updated or deleted via systems in communication with the API's. For example, personnel 2202 of the lease-to-own company or retailer 102 may create, retrieve, update and delete offers by use of a computer 2204 (example: via a web browser installed thereon by which the personnel 2202 accesses a website that communicates with the API's of the processes 2200).

The backend system 108 also includes processes 2206 that may be accessed to retrieve the particular offers that are within a user's wallet. The capabilities of the processes 2206 may be exposed as one or more application interfaces (API's) via endpoints so that offers may be retrieved. Process 2206 is responsive to an invocation including data identifying a user. Upon invocation, the process 2206 returns a set of offers organized as previously described. The app 2201, therefore, may call the process 2206 (such as by directing an HTTP command to an endpoint) to retrieve the set of offers to be displayed in the wallet of the particular user that is logged into the app 2201.

According to some embodiments, the process 2206 obtains a list or set of offers organized as described previously as described below. The backend system 108 executes a process 2208 that functions as a propensity model. The process 2208 accesses a particular user's account data (stored in data store 112), and uses the user's recent lease-to-own transactions as input data. Based upon the user's recent transactions, the model 2208 generates a list of offer types that are likely to be of interest to the user. For example, if a given user recent leased a television, the model process 2208 may generate a list organized conceptually as:
{home theater equipment, video game consoles, family room furniture}

The list indicates that home theater equipment is likely to be of interest to the user, given his recent transaction history, and video game consoles are also likely to be of interest, albeit a little less likely, and so on. Thus, the list is rank ordered in terms of interest propensity. The model process 2208 communicates the list to a queue process 2210.

The queue process 2210 accesses the data store to retrieve offers in the categories contained in the list provided to it by the model 2208. According to some embodiments, the queue 2210 retrieves all such offers extended by retailers within a certain radius of the user's position (if known) or home address. The queue 2210 then arranges these offers in rank order on a blended basis of propensity model rank, retailer proximity, and size of discount. According to some embodiments, a rank order value is calculated for each offer retrieved by the queue process 2210. For example, the rank order value of each offer may be calculated by a linear model that applies weights to each aforementioned variable. The queue 2210 arranges the offers in a list or set according to the rank order value, either arranging them in the order of least-to-greatest rank order value, or vice versa. The queue process 2210 provides the ordered list to process 2206 for delivery to the app 2201.

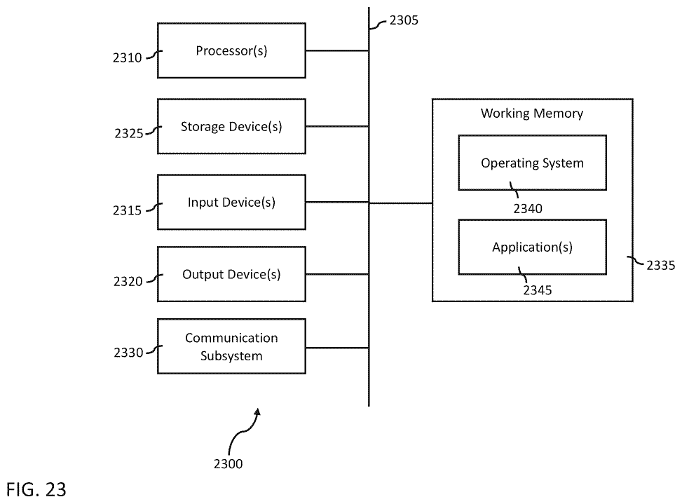

To perform the actions of the device 102, host the backend platform 108, the authorization platform 110, run web browsers to permit interaction with the websites, or execute any of the methods or schemes herein and/or embody any of the other previously mentioned computing devices, a computer or server system as illustrated in FIG. 23 may be used. FIG. 23 depicts a schematic illustration of one embodiment of a computer system 2300 that can perform the methods provided by various other embodiments, as described herein, and/or can function as the host computer system, a server system, a laptop, tablet, smartphone, a mobile device, and/or a computer system. It should be noted that FIG. 23 is meant only to provide a generalized illustration of various components, any or all of which may be utilized as appropriate. FIG. 23, therefore, broadly illustrates how individual system elements may be implemented in a relatively separated or relatively more integrated manner.

The computer system 2300 is shown comprising hardware elements that can be electrically coupled via a bus 2305 (or may otherwise be in communication, as appropriate). The hardware elements may include one or more processors 2310, including without limitation one or more general-purpose processors and/or one or more special-purpose processors (such as digital signal processing chips, graphics acceleration processors, and/or the like); one or more input devices 2315, which can include without limitation a mouse, a keyboard, touchscreen and/or the like; and one or more output devices 2320, which can include without limitation a display device, a printer and/or the like.

The computer system 2300 may further include (and/or be in communication with) one or more storage devices 2325, which can comprise, without limitation, local and/or network accessible storage, and/or can include, without limitation, a disk drive, a drive array, an optical storage device, a solid-state storage device such as a random access memory (“RAM”) and/or a read-only memory (“ROM”), which can be programmable, flash-updateable and/or the like. Such storage devices may be configured to implement any appropriate data stores, including without limitation, various file systems, database structures, and/or the like.

The computer system 2300 may also include a communications subsystem 2330, which can include without limitation a modem, a network card (wireless or wired), an infrared communication device, a wireless communication device and/or chipset (such as a BLUETOOTH™ device, an 802.11 device, a WiFi device, a WiMax device, cellular communication facilities, etc.), and/or the like. The communications subsystem 2330 may permit data to be exchanged with a network (such as the network described below, to name one example), other computer systems, and/or any other devices described herein. In many embodiments, the computer system 2300 will further comprise a working memory 2335, which can include a RAM or ROM device, as described above.

The computer system 2300 also can comprise software elements, shown as being currently located within the working memory 2335, including an operating system 2340, device drivers, executable libraries, and/or other code, such as one or more application programs 2345, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a computer-readable storage medium, such as the storage device(s) 2325 described above. In some cases, the storage medium might be incorporated within a computer system, such as the system 2300. In other embodiments, the storage medium might be separate from a computer system (e.g., a removable medium, such as a compact disc), and or provided in an installation package, such that the storage medium can be used to program, configure and/or adapt a general purpose computer with the instructions/code stored thereon. These instructions might take the form of executable code, which is executable by the computer system 2300 and/or might take the form of source and/or installable code, which, upon compilation and/or installation on the computer system 2300 (e.g., using any of a variety of generally available compilers, installation programs, compression/decompression utilities, etc.) then takes the form of executable code.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer system (such as the computer system 2300) to perform methods in accordance with various embodiments of the invention. According to a set of embodiments, some or all of the procedures of such methods are performed by the computer system 2300 in response to processor 2310 executing one or more sequences of one or more instructions (which might be incorporated into the operating system 2340 and/or other code, such as an application program 2345) contained in the working memory 2335. Such instructions may be read into the working memory 2335 from another computer-readable medium, such as one or more of the storage device(s) 2325. Merely by way of example, execution of the sequences of instructions contained in the working memory 2335 might cause the processor or processors 2310 to perform one or more procedures of the methods described herein.

The terms “machine-readable medium” and “computer-readable medium,” as used herein, refer to any medium that participates in providing data that causes a machine to operate in a specific fashion. In an embodiment implemented using the computer system 2300, various computer-readable media might be involved in providing instructions/code to the processor or processors 2310 for execution and/or might be used to store and/or carry such instructions/code (e.g., as signals). In many implementations, a computer-readable medium is a physical and/or tangible storage medium. Such a medium may take many forms, including but not limited to, non-volatile media, volatile media, and transmission media. Non-volatile media include, for example, optical and/or magnetic disks, such as the storage device(s) 2325. Volatile media include, without limitation, dynamic memory, such as the working memory 2335. Transmission media include, without limitation, coaxial cables, copper wire and fiber optics, including the wires that comprise the bus 2305, as well as the various components of the communication subsystem 2330 (and/or the media by which the communications subsystem 2330 provides communication with other devices). Hence, transmission media can also take the form of waves (including without limitation radio, acoustic and/or light waves, such as those generated during radio-wave and infrared data communications).

Common forms of physical and/or tangible computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, EPROM, a FLASH-EPROM, any other memory chip or cartridge, a carrier wave as described hereinafter, or any other medium from which a computer can read instructions and/or code.

Various forms of computer-readable media may be involved in carrying one or more sequences of one or more instructions to the processor or processors 2310 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 2300. These signals, which might be in the form of electromagnetic signals, acoustic signals, optical signals and/or the like, are all examples of carrier waves on which instructions can be encoded, in accordance with various embodiments of the invention.

The communications subsystem 2330 (and/or components thereof) generally will receive the signals, and the bus 2305 then might carry the signals (and/or the data, instructions, etc. carried by the signals) to the working memory 2335, from which the processor(s) 2305 retrieves and executes the instructions. The instructions received by the working memory 2335 may optionally be stored on a storage device 2325 either before or after execution by the processor(s) 2310.

The various embodiments described above are provided by way of illustration only and should not be construed to limit the invention. Those skilled in the art will readily recognize various modifications and changes that may be made to the present invention without departing from the true spirit and scope of the present invention, which is set forth in the following claims.

The claimed invention is:

1. A system for disbursement of funds associated with a multiparty transaction, the system comprising:
a computing device including a processing unit and a memory communicably connected with and readable by the processing unit, the memory containing instructions that, when executed by the processing unit, cause the processing unit to:
execute a web browser extension in response to a web browser executing on said processing unit having been navigated to a shopping cart page of a retail website, wherein said web browser extension includes instructions that, when executed, cause:
information from said shopping cart to be read by said web browser extension;
a constraint to be imposed by said web browser extension upon said multiparty transaction based upon said information; and
upon said web browser extension determining satisfaction of said constraint, said disbursement of funds to be initiated by said web browser extension, wherein said web browser extension initiates said disbursement of funds by injecting data into at least one field on a payment page native to said retail website.

2. The system of claim 1, wherein the information from the shopping cart read by the web browser extension includes products included in the shopping cart.

3. The system of claim 2, wherein the determining satisfaction of the constraint imposed includes comparing the products included in the shopping cart to a whitelist.

4. The system of claim 3, further comprising a backend computing platform having a datastore, wherein the whitelist is stored in the datastore.

5. The system of claim 3, the determining satisfaction of the constraint imposed includes determining whether the products included in the shopping cart are consumable or disposable.

6. The system of claim 1, wherein the disbursement of funds includes a lease-to-own transaction.

7. The system of claim 1, wherein the injecting data into the at least one field on the payment page native to the retail website includes injecting credit card information.

8. The system of claim 7, wherein the injecting data into the at least one field on the payment page native to the retail website includes injecting virtual credit card (VCC) information.

9. The system of claim 8, further comprising a backend computing platform including a backend processing unit and a memory communicably connected with and readable by the backend processing unit, the memory unit containing instructions that, when executed by the backend processing unit, cause the backend processing unit to create the VCC.

10. The system of claim 9, wherein the web browser is navigated to the shopping cart by a consumer.

11. The system of claim 10, wherein the backend computing platform includes a data store communicably connected with and readable by the backend processing unit, the data store including information regarding the consumer, wherein the backend processing unit creates the VCC based on the information regarding the consumer.

12. A method for disbursement of funds associated with a multiparty transaction, the method comprising:
executing a web browser extension in response to a web browser having been navigated to a shopping cart page of a retail website;
reading information from the shopping cart by the web browser extension;
imposing a constraint by the web browser extension upon the multiparty transaction based upon the information;
determining satisfaction of the constraint by the web browser extension; and
initiating a disbursement of funds by said web browser extension, including injecting data into at least one field on a payment page native to the retail website.

13. The method of claim 12, wherein the information from the shopping cart read by the web browser extension includes products included in the shopping cart.

14. The method of claim 13, wherein the determining satisfaction of the constraint imposed includes comparing the products included in the shopping cart to a whitelist.

15. The method of claim 14, wherein the determining satisfaction of the constraint imposed includes accessing the whitelist on a datastore of a backend computing platform.

16. The method of claim 12, wherein the injecting data into the at least one field on the payment page native to the retail website includes injecting virtual credit card (VCC) information.

17. The method of claim 16, further comprising creating the VCC based on the information read from the shopping cart by the web browser extension, and based on information regarding a consumer navigating the web browser to the shopping cart page of the retail website.

18. A computer readable medium containing instructions operable to execute a method for disbursement of funds associated with a multiparty transaction, comprising:
determining that a web browser has been navigated to a shopping cart page of a retail website;
in response to the determination, executing a web browser extension;
reading information regarding products stored in the shopping cart by the web browser extension;
comparing the information regarding the products to a whitelist; and
based on the comparison, injecting data into at least one field on a payment page native to the retail website by the web browser extension.

19. The medium of claim 18, wherein the executed method further comprises accessing the whitelist on a datastore of a backend computing system.

20. The medium of claim 18, wherein the injecting data into the at least one field on the payment page native to the retail website includes injecting virtual credit card (VCC) information.
